(19) United States
(12) Patent Application Publication
(10) Pub. No.: US 2006/0034259 A1
(43) Pub. Date: Feb. 16, 2006

(54) Communication system, electronic device, eletronic device controlling method, information providing apparatus, information providing method, recording medium, and program

(75) Inventor: Satoru Matsuda, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: SONY CORPORATION, Tokyo (JP)

(21) Appl. No.: 11/195,822

(22) Filed: Aug. 3, 2005

(30) Foreign Application Priority Data
Aug. 10, 2004 (JP) 2004-233009

(51) Int. Cl. H04L 12/66; H04L 12/56

(52) U.S. Cl. 370/352; 370/401

(57) ABSTRACT

An information processing method is disclosed which includes the steps of sending a first request asking sending of first information related to a device, to a first information providing apparatus providing the first information, receiving the first information sent from the first information providing apparatus, determining whether the first information providing apparatus is connected to a network based on the first information received in the receiving step, storing connection information for connecting to a second information providing apparatus providing second information related to a user, controlling sending to the second information providing apparatus of a second request asking sending of the second information related to the user in accordance with the connection information if the determining step determines that the first information providing apparatus is not connected to the network, controlling reception of the second information sent from the second information providing apparatus, generating control data for controlling the device designated by the first information in accordance with the first and the second information, and controlling the device based on operations performed by the user and on the control data.

### CROSS REFERENCES TO RELATED APPLICATIONS

The present invention contains subject matter related to Japanese Patent Application 2004-233009 filed in the Japanese Patent Office on Aug. 10, 2004, the entire contents of which being incorporated herein by reference.

### BACKGROUND OF THE INVENTION

The present invention relates to a communication system, an electronic device, an electronic device controlling method, an information processing apparatus, an information processing method, a recording medium, and a program. More particularly, the invention relates to a communication system, an electronic device, an electronic device controlling method, an information processing apparatus, an information processing method, a recording medium, and a program for connecting a mobile phone to the Internet to acquire information.

Recent years have witnessed the widespread use of portable personal computers and mobile phones. The trend has involved numerous users carrying around devices with communication and information processing capabilities. Whether out of doors or on the move, the users of these devices connect to networks to conduct network-based communications.

There exist services that allow the user of a mobile phone to communicate with a home appliance in a place where the user happens to be around. Once communication is established with the home appliance on the premises, the mobile phone is allowed to connect through the appliance to the Internet to acquire information. One such service is disclosed, for example, in Japanese Patent Laid-Open No. 2004-96743 (hereinafter referred to as Patent Document 1).

### SUMMARY OF THE INVENTION

The above-cited service in patent document 1 requires the home appliance to connect to the Internet through one of the access points on the Internet. If there is no access point in the vicinity, the service is not available.

Conceivably, access points of wireless LAN (Local Area Networks) or Bluetooth radio link-up known as hot spots could be set up to provide wireless Internet connection services to the general public. In practice, it is difficult to implement such services because of the vast amount of investment needed to put the necessary infrastructure in place.

The present invention has been made in view of the above circumstances and provides arrangements for allowing a mobile phone to access the Internet through a mobile phone network to acquire information without requiring any home appliance on the premises to connect to an Internet access point.

According to an embodiment of the present invention, there is provided a communication system including an electronic device, a first information providing apparatus providing first information related to a device, and a second information providing apparatus providing second information related to a user; wherein the electronic device includes: first sending means sending to the first information providing apparatus a first request asking sending of the first information; first receiving means receiving the first information sent from the first information providing apparatus; determining means determining whether the first information providing apparatus is connected to a network based on the first information received by the first receiving means; storing means storing connection information for connecting to the second information providing apparatus; sending controlling means which, if the determining means determines that the first information providing apparatus is not connected to the network, then controls sending to the second information providing apparatus of a second request asking sending of the second information based on the connection information; reception controlling means controlling reception of the second information sent from the second information providing apparatus; generating means generating control data for controlling the device designated by the first information, in accordance with the first and the second information; and device controlling means controlling the device based on operations performed by the user and on the control data; wherein the first information providing apparatus includes: second receiving means receiving the first request sent from the electronic device; first information storing means storing the first information; and second sending means sending the first information from the first information storing means to the electronic device in accordance with the first request received by the second receiving means; and wherein the second information providing apparatus includes: third receiving means receiving the second request of which the sending is controlled by the electronic device; second information storing means storing the second information; and third sending means sending the second information from the second information storing means to the electronic device in accordance with the second request received by the third receiving means.

According to another embodiment of the present invention, there is provided an electronic device including: sending means sending a first request asking sending of first information related to a device, to a first information providing apparatus providing the first information; receiving means receiving the first information sent from the first information providing apparatus; determining means determining whether the first information providing apparatus is connected to a network based on the first information received by the receiving means; storing means storing connection information for connecting to a second information providing apparatus providing second information related to a user; sending controlling means which, if the determining means determines that the first information providing apparatus is not connected to the network, then controls sending to the second information providing apparatus of a second request asking sending of the second information related to the user in accordance with the connection information; reception controlling means controlling reception of the second information sent from the second information providing apparatus; generating means generating control data for controlling the device designated by the first information in accordance with the first and the second information; and device controlling means controlling the device based on operations performed by the user and on the control data.

Preferably, the electronic device according to the invention may further include display controlling means controlling display of information specific to the user about the device in accordance with the control data.

Preferably, the sending controlling means may cause a communication apparatus to which the electronic device is attached to send the second request; and the reception controlling means may cause the communication apparatus to receive the second information.

According to another embodiment of the present invention, there is provided an information processing method including the steps of: sending a first request asking sending of first information related to a device, to a first information providing apparatus providing the first information; receiving the first information sent from the first information providing apparatus; determining whether the first information providing apparatus is connected to a network based on the first information received in the receiving step; storing connection information for connecting to a second information providing apparatus providing second information related to a user; controlling sending to the second information providing apparatus of a second request asking sending of the second information related to the user in accordance with the connection information, if the determining step determines that the first information providing apparatus is not connected to the network; controlling reception of the second information sent from the second information providing apparatus; generating control data for controlling the device designated by the first information in accordance with the first and the second information; and controlling the device based on operations performed by the user and on the control data.

According to another embodiment of the present invention, there is provided a recording medium which stores a program in a manner readable by a computer, the program including the steps of: sending a first request asking sending of first information related to a device, to a first information providing apparatus providing the first information; receiving the first information sent from the first information providing apparatus; determining whether the first information providing apparatus is connected to a network based on the first information received in the receiving step; storing connection information for connecting to a second information providing apparatus providing second information related to a user; controlling sending to the second information providing apparatus of a second request asking sending of the second information related to the user in accordance with the connection information, if the determining step determines that the first information providing apparatus is not connected to the network; controlling reception of the second information sent from the second information providing apparatus; generating control data for controlling the device designated by the first information in accordance with the first and the second information; and controlling the device based on operations performed by the user and on the control data.

According to another embodiment of the present invention, there is provided a program including the steps of: sending a first request asking sending of first information related to a device, to a first information providing apparatus providing the first information; receiving the first information sent from the first information providing apparatus; determining whether the first information providing apparatus is connected to a network based on the first information received in the receiving step; storing connection information for connecting to a second information providing apparatus providing second information related to a user; controlling sending to the second information providing apparatus of a second request asking sending of the second information related to the user in accordance with the connection information, if the determining step determines that the first information providing apparatus is not connected to the network; controlling reception of the second information sent from the second information providing apparatus; generating control data for controlling the device designated by the first information in accordance with the first and the second information; and controlling the device based on operations performed by the user and on the control data.

Where the communication system according to the invention is in use, the electronic device sends to the first information providing apparatus a first request asking sending of the first information, and receives the first information from the first information providing apparatus. The electronic device then determines whether the first information providing apparatus is connected to a network based on the received first information. The electronic device further stores connection information for connecting to the second information providing apparatus. If it is determined that the first information providing apparatus is not connected to the network, then the electronic device sends to the second information providing apparatus a second request asking sending of the second information based on the connection information. The electronic device further receives the second information from the second information providing apparatus, and generates control data for controlling the device designated by the first information in accordance with the first and the second information, thereby controlling the device based on operations performed by the user and on the control data. The first information providing apparatus receives the first request from the electronic device and stores the first information. The first information providing apparatus then sends the stored first information to the electronic device in accordance with the received first request. The second information providing apparatus receives the second request of which the sending is controlled by the electronic device, stores the second information, and sends the stored second information to the electronic device in accordance with the received second request.

Where the electronic device, information processing method, recording medium, and program according to the invention are in use, a first request asking sending of first information related to a device is sent to a first information providing apparatus providing the first information. The first information is received from the first information providing apparatus. A check is made to determine whether the first information providing apparatus is connected to a network based on the received first information. Connection information is stored for use in connecting to a second information providing apparatus providing second information related to a user. If it is determined that the first information providing apparatus is not connected to the network, then a second request asking sending of the second information related to the user is sent to the second information providing apparatus in accordance with the connection information. The second information is received from the second information providing apparatus. Control data is generated for use in controlling the device designated by the first information in accordance with the first and the second information. The device is then controlled based on operations performed by the user and on the control data.

According to the invention, it is possible to acquire information by connecting to the Internet through the mobile phone. Even in a place where the user is unable to access the Internet, the inventive scheme allows some devices on the premises to be controlled according to the user's preference or in accordance with the user's subscription to services.

### BRIEF DESCRIPTION OF THE DRAWINGS

Further objects and advantages of this invention will become apparent upon a reading of the following description and appended drawings in which:

FIG. 1 is a schematic view showing a typical configuration of a communication system to which the present invention is applied;

FIG. 2 is a block diagram showing a typical structure of a mobile adapter;

FIG. 3 is a block diagram showing a typical functional structure of the mobile adapter;

FIG. 4 is a block diagram showing a typical structure of a mobile phone;

FIG. 5 is a block diagram showing a typical structure of a home appliance;

FIG. 6 is a block diagram showing a typical structure of another home appliance;

FIG. 7 is a block diagram showing a typical structure of a personal computer;

FIG. 8 is a sequence diagram outlining overall processing of the communication system;

FIG. 9 is a tabular view showing typical SDR information held in a space directory (SDR);

FIG. 10 is a tabular view showing typical PDR information held in a personal directory (PDR);

FIG. 11 is a tabular view showing another typical SDR information held in the space directory (SDR);

FIG. 12 is a schematic view of a typical display screen on a mobile phone displaying the names of devices communicable with the mobile adapter;

FIG. 13 is a tabular view showing another typical PDR information held in the personal directory (PDR);

FIG. 14 is a tabular view showing a typical structure of an operation menu;

FIG. 15 is a schematic view showing a typical display screen on a mobile phone displaying a list of available channels;

FIG. 16 is a flowchart of steps constituting a PDR information acquiring process;

FIG. 17 is a flowchart of steps constituting another PDR information acquiring process;

FIG. 18 is a flowchart of steps constituting an SDR information sending process;

FIG. 19 is a flowchart of steps constituting another SDR information sending process;

FIG. 20 is a flowchart of steps constituting another PDR information acquiring process;

FIG. 21 is a flowchart of steps constituting a PDR information sending process;

FIG. 22 is a flowchart of steps constituting a device information sending process; and

FIG. 23 is a flowchart of steps constituting a device information storing process.

### DETAILED DESCRIPTION OF THE PREFERRED EMBODIMENTS

What is described below as the preferred embodiments of this invention corresponds to the appended claims as follows: the description of the preferred embodiments basically provides specific examples supporting what is claimed. If any example of the invention described below as a preferred embodiment does not have an exactly corresponding claim, this does not means that the example in question has no relevance to the claims. Conversely, if any example of the invention described hereinunder has a specifically corresponding claim, this does not mean that the example in question is limited to that claim or has no relevance to other claims.

Furthermore, the description below of the preferred embodiments does not claim to include all examples corresponding to the whole claims. In other words, the description hereinunder does not limit or deny any inventive entities which are not covered by the appended claims of this invention but which may be added or brought about by this applicant in the future by divisional application or by amendment.

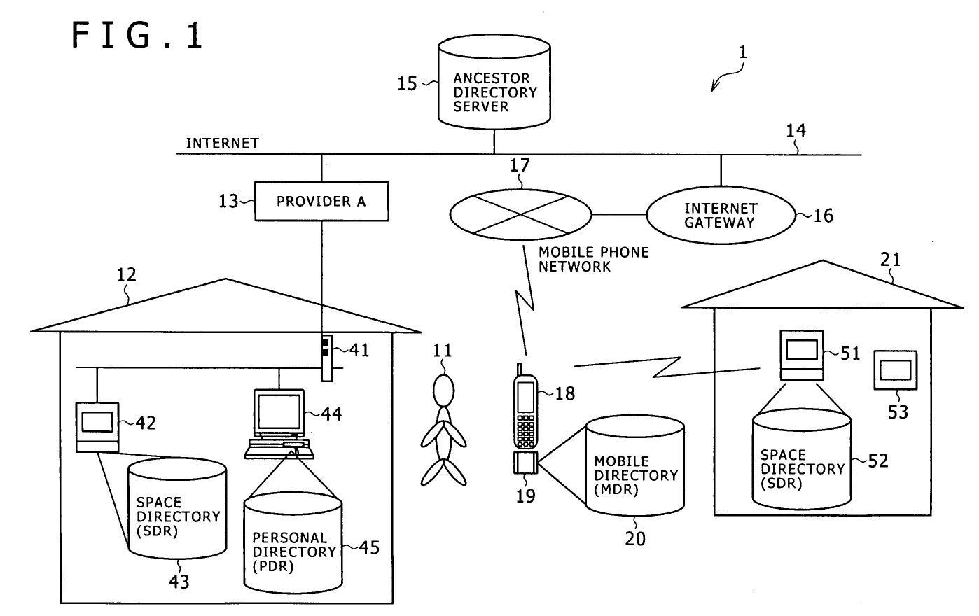

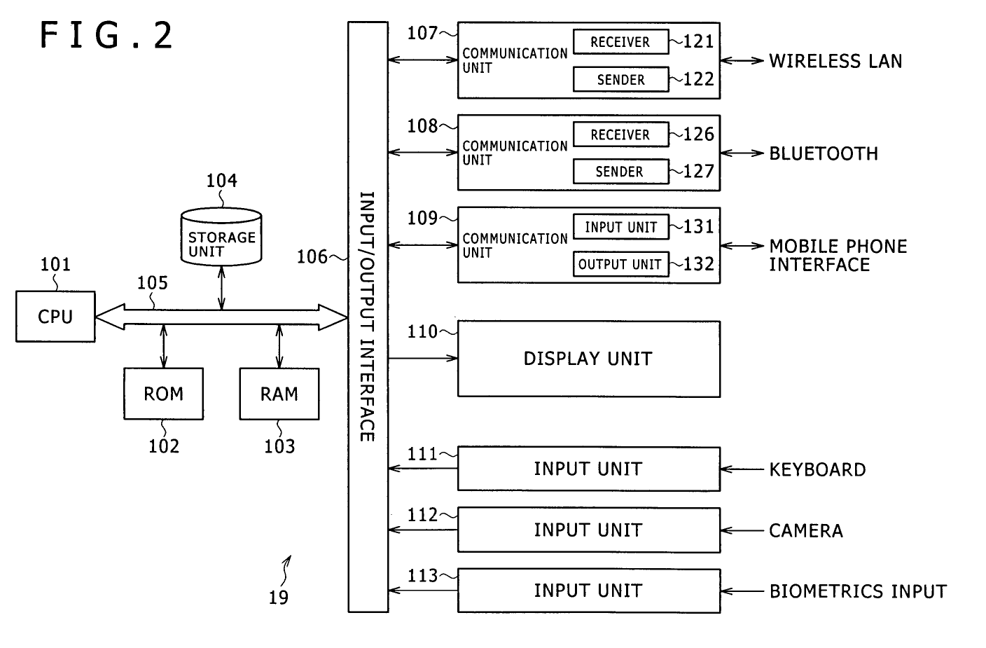

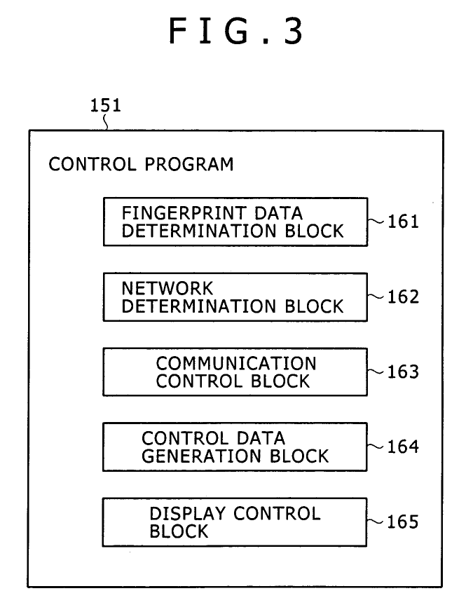

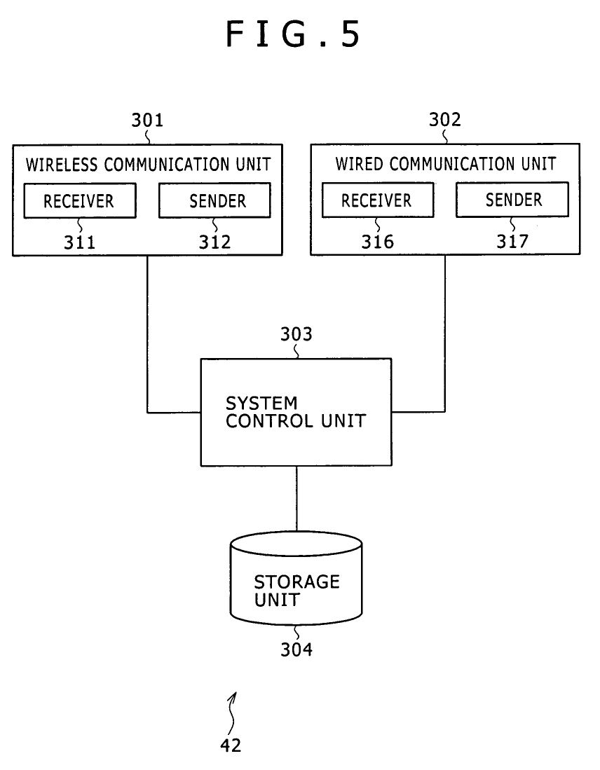

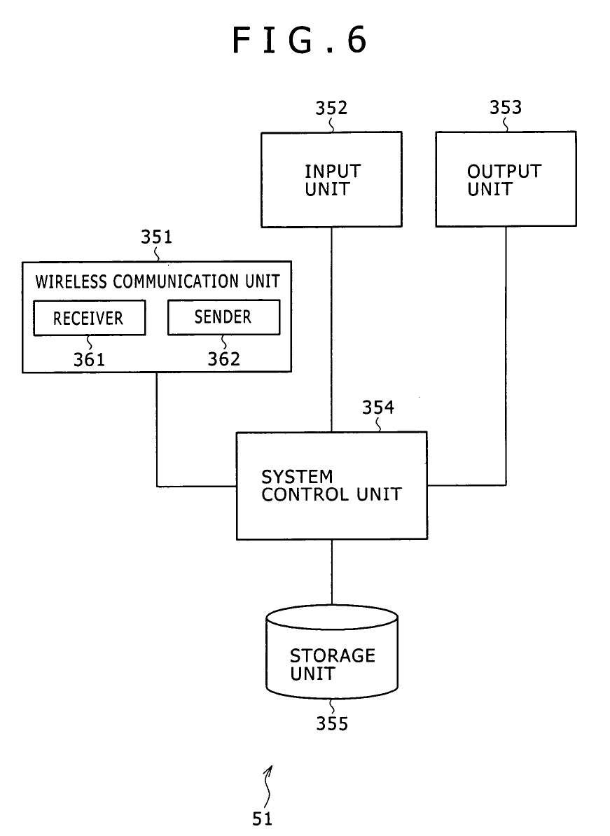

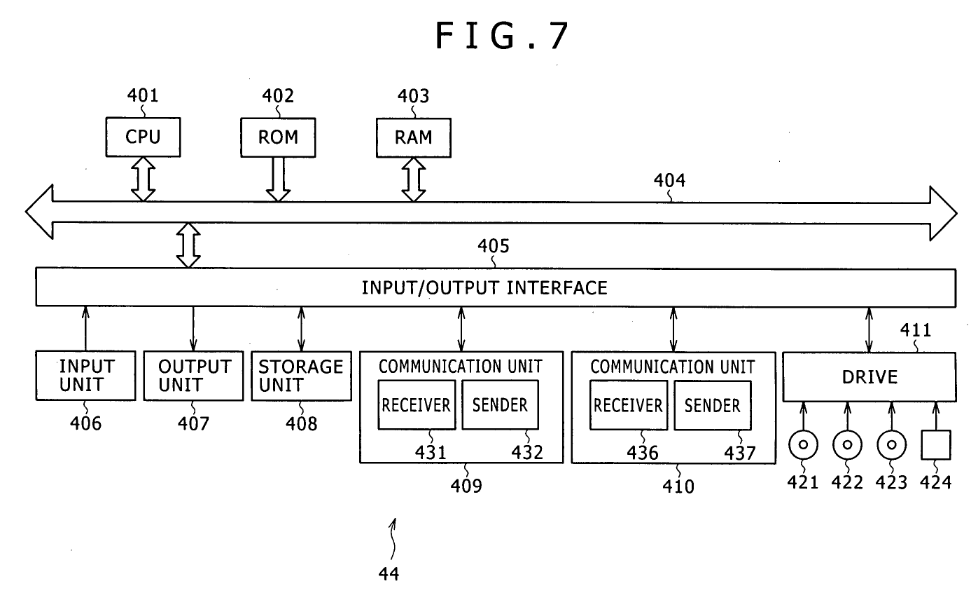

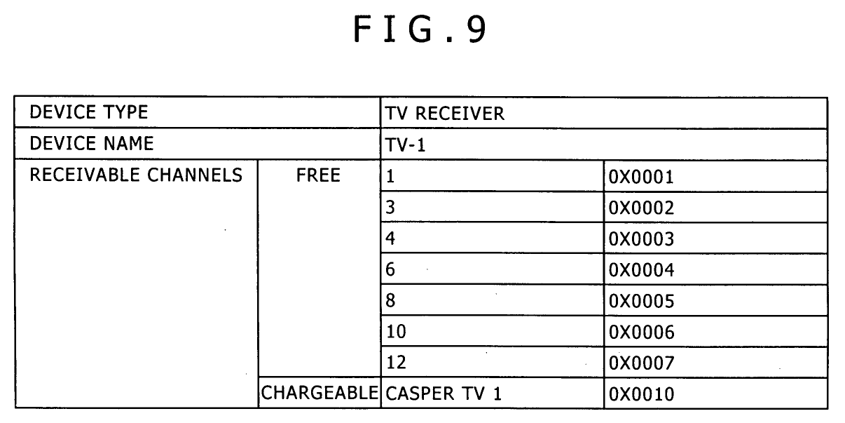

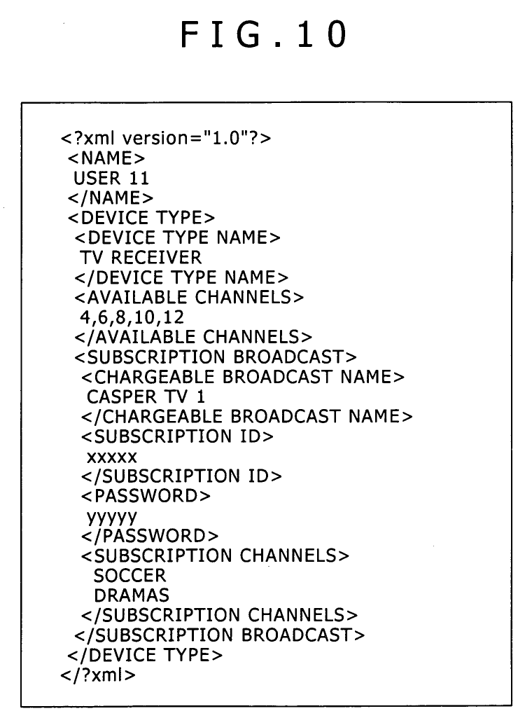

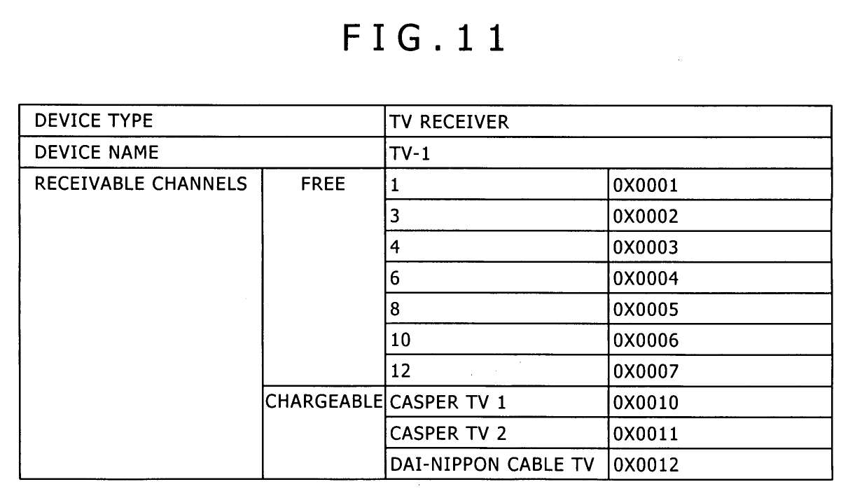

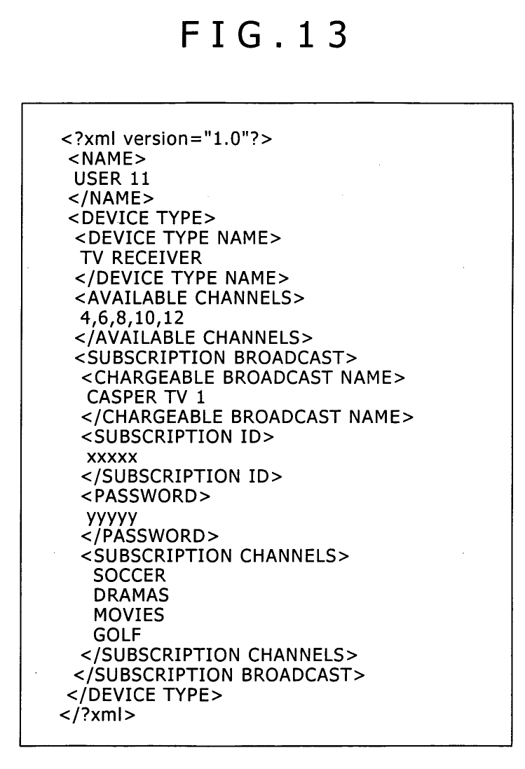

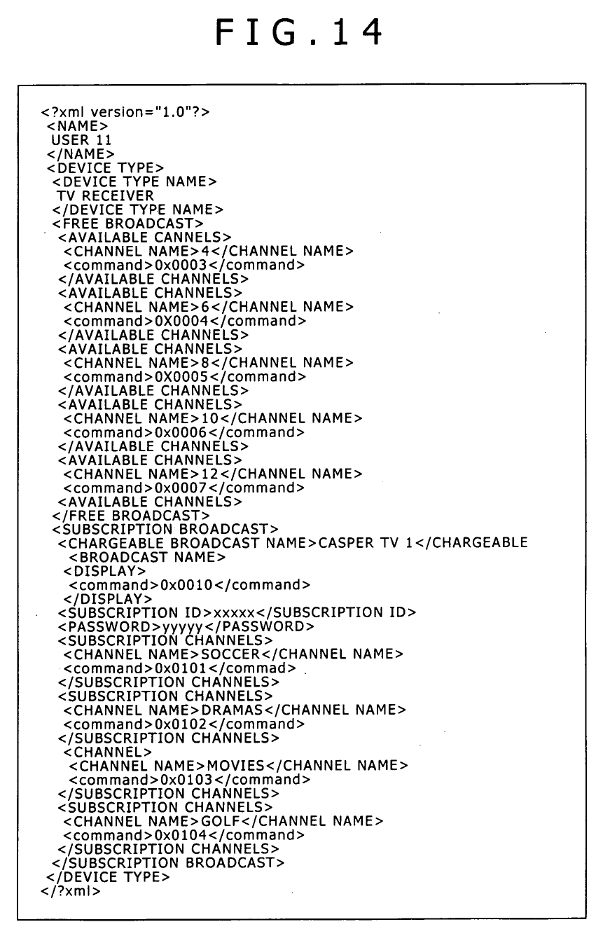

One embodiment of the present invention is a communication system including an electronic device (e.g., mobile adapter 19 in FIG. 1), a first information providing apparatus (e.g., home appliance 42 or 51 in FIG. 1) providing first information (e.g., SDR information in FIG. 9 or FIG. 11) related to a device, and a second information providing apparatus (e.g., personal computer 44 in FIG. 1) providing second information (e.g., PDR information in FIG. 10 or FIG. 13) related to a user; wherein the electronic device includes: first sending means (e.g., sender 122 or 127 of a communication unit 107 or 108 in FIG. 2) sending to the first information providing apparatus a first request (e.g., SDR detection request) asking sending of the first information; first receiving means (e.g., receiver 121 or 126 of the communication unit 107 or 108 in FIG. 2) receiving the first information sent from the first information providing apparatus; determining means (e.g., network determination block 162 in FIG. 3) determining whether the first information providing apparatus is connected to a network based on the first information received by the first receiving means; storing means (e.g., storage unit 104 in FIG. 2) storing connection information (e.g., device ID of the personal computer 44 whose personal directory (PDR) 45 is active in FIG. 1) for connecting to the second information providing apparatus; sending controlling means (e.g., communication control block 163 in FIG. 3 for controlling an output unit 132 of a communication unit 109 in FIG. 2) which, if the determining means determines that the first information providing apparatus is not connected to the network, then controls sending to the second information providing apparatus of a second request (e.g., PDR acquisition request) asking sending of the second information based on the connection information; reception controlling means (e.g., communication control block 163 in FIG. 3 for controlling an input unit 131 of the communication unit 109 in FIG. 2) controlling reception of the second information sent from the second information providing apparatus; generating means (e.g., control data generation block 164 in FIG. 3) generating control data (e.g., operation menu structure in FIG. 14) for controlling the device designated by the first information, in accordance with the first and the second information; and device controlling means (e.g., communication control block 163 in FIG. 3 for controlling the communication unit 107 or 108 in FIG. 2) controlling the device based on operations performed by the user and on the control data; wherein the first information providing apparatus includes: second receiving means (e.g., a receiver 311 of a wireless communication unit 301 in FIG. 5 or a receiver 361 of a wireless communication unit 351 in FIG. 6) receiving the first request sent from the electronic device; first information storing means (e.g., space directory (SDR) 43 or 52 in FIG. 1) storing the first information; and second sending means (e.g., a sender 312 of the wireless communication unit 301 in FIG. 5 or a sender 362 of the wireless communication unit 351 in FIG. 6) sending the first information from the first information storing means to the electronic device in accordance with the first request received by the second receiving means; and wherein the second information providing apparatus includes: third receiving means (e.g., receiver 431 or 436 of a communication unit 409 or 410 in FIG. 7) receiving the second request of which the sending is controlled by the electronic device; second information storing means (e.g., the personal directory (PDR) 45 in FIG. 1) storing the second information; and third sending means (e.g., sender 432 or 437 of the communication unit 409 or 410 in FIG. 7) sending the second information from the second information storing means to the electronic device in accordance with the second request received by the third receiving means.

Another embodiment of the present invention is an electronic device (e.g., mobile adapter 19 in FIG. 1) including: sending means (e.g., sender 122 or 127 of the communication unit 107 or 108 in FIG. 2) sending a first request (e.g., SDR detection request) asking sending of first information (e.g., SDR information in FIG. 9 or FIG. 11) related to a device, to a first information providing apparatus (e.g., home appliance 42 or 51 in FIG. 1) providing the first information; receiving means (e.g., receiver 121 or 126 of the communication unit 107 or 108 in FIG. 2) receiving the first information sent from the first information providing apparatus; determining means (e.g., network determination block 162 in FIG. 3) determining whether the first information providing apparatus is connected to a network based on the first information received by the receiving means; storing means (e.g., storage unit 104 in FIG. 2) storing connection information (e.g., device ID of the personal computer 44 whose personal directory (PDR) 45 is active in FIG. 1) for connecting to a second information providing apparatus (e.g., personal computer 44 in FIG. 1) providing second information (e.g., PDR information in FIG. 10 or FIG. 13) related to a user; sending controlling means (e.g., communication control block 163 in FIG. 3 for controlling the output unit 132 of the communication unit 109 in FIG. 2) which, if the determining means determines that the first information providing apparatus is not connected to the network, then controls sending to the second information providing apparatus of a second request (e.g., PDR acquisition request) asking sending of the second information related to the user in accordance with the connection information; reception controlling means (e.g., communication control block 163 in FIG. 3 for controlling the input unit 131 of the communication unit 109 in FIG. 2) controlling reception of the second information sent from the second information providing apparatus; generating means (e.g., control data generation block 164 in FIG. 3) generating control data for controlling the device designated by the first information in accordance with the first and the second information; and device controlling means (e.g., communication control block 163 in FIG. 3 for controlling the communication unit 107 or 108 in FIG. 2) controlling the device based on operations performed by the user and on the control data.

Preferably, the electronic device according to the invention may further include display controlling means (e.g., display control block 165 in FIG. 3) controlling display of information specific to the user about the device in accordance with the control data.

Preferably, the sending controlling means may cause a communication apparatus (e.g., mobile phone 18 in FIG. 1) to which the electronic device is attached to send the second request; and the reception controlling means may cause the communication apparatus to receive the second information.

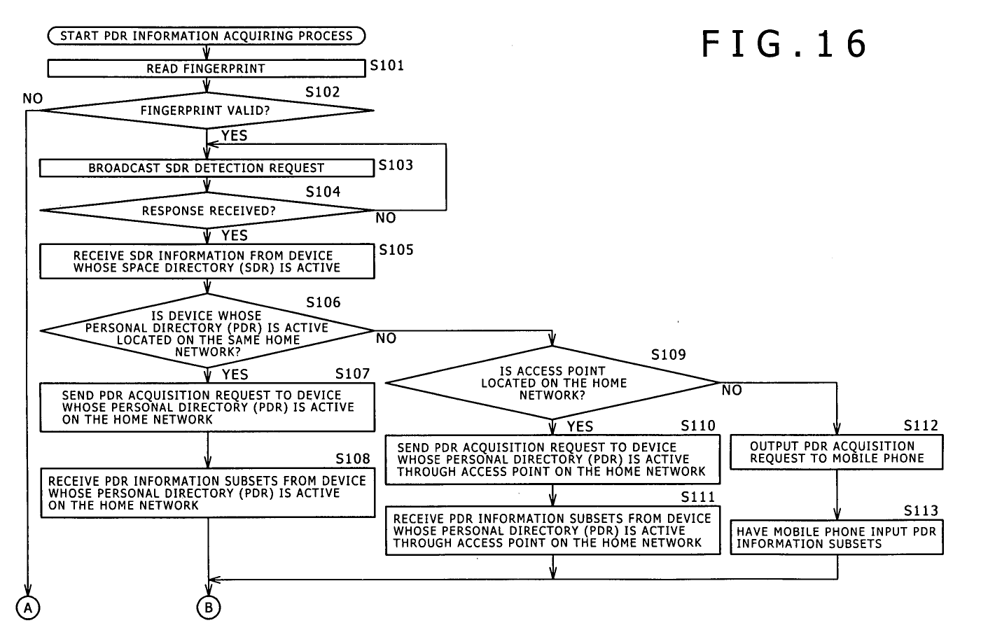

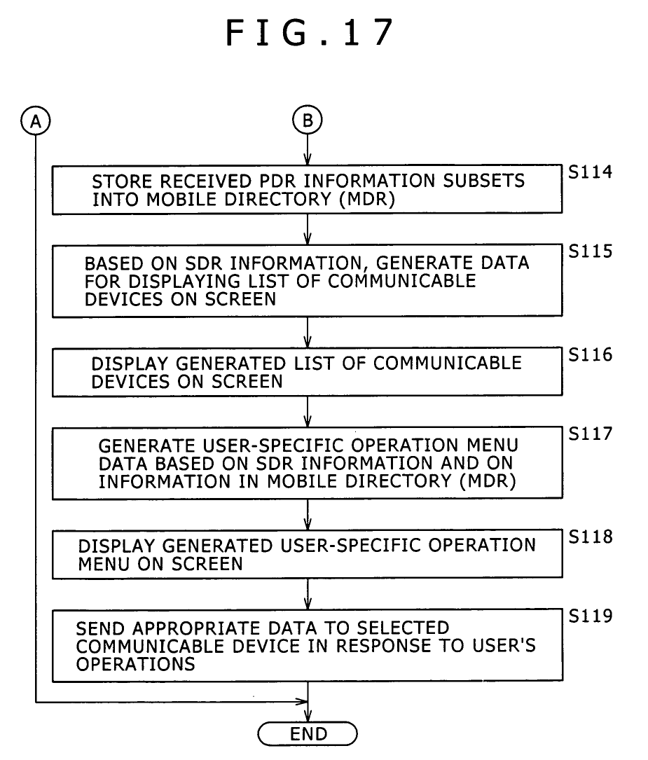

Another embodiment of the present invention is an information processing method including the steps of: sending (e.g., in step S103 of FIG. 16) a first request asking sending of first information related to a device, to a first information providing apparatus providing the first information; receiving (e.g., in step S105 of FIG. 16) the first information sent from the first information providing apparatus; determining (e.g., in step S109 of FIG. 16) whether the first information providing apparatus is connected to a network based on the first information received in the receiving step; storing connection information for connecting to a second information providing apparatus providing second information related to a user; controlling sending (e.g., in step S112 of FIG. 16) to the second information providing apparatus of a second request asking sending of the second information related to the user in accordance with the connection information, if the determining step determines that the first information providing apparatus is not connected to the network; controlling reception (e.g., in step S113 of FIG. 16) of the second information sent from the second information providing apparatus; generating (e.g., in step S117 of FIG. 17) control data for controlling the device designated by the first information in accordance with the first and the second information; and controlling (e.g., in step S119 of FIG. 16) the device based on operations performed by the user and on the control data.

Another embodiment of the present invention is a program including the steps of: sending (e.g., in step S103 of FIG. 16) a first request asking sending of first information related to a device, to a first information providing apparatus providing the first information; receiving (e.g., in step S105 of FIG. 16) the first information sent from the first information providing apparatus; determining (e.g., in step S109 of FIG. 16) whether the first information providing apparatus is connected to a network based on the first information received in the receiving step; storing connection information for connecting to a second information providing apparatus providing second information related to a user; controlling sending (e.g., in step S112 of FIG. 16) to the second information providing apparatus of a second request asking sending of the second information related to the user in accordance with the connection information, if the determining step determines that the first information providing apparatus is not connected to the network; controlling reception (e.g., in step S113 of FIG. 16) of the second information sent from the second information providing apparatus; generating (e.g., in step S117 of FIG. 17) control data for controlling the device designated by the first information in accordance with the first and the second information; and controlling (e.g., in step S119 of FIG. 17) the device based on operations performed by the user and on the control data.

The inventive program above may be stored on a recording medium.

The preferred embodiments of the present invention will now be described with reference to the accompanying drawings.

FIG. 1 is a schematic view showing a typical configuration of a communication system 1 to which this invention is applied.

A user 11 utilizes various devices including a personal computer, a TV receiver, and home information appliances connected on a local network at the user's home 12. These devices are in turn connected to a provider A 13 (communication service provider) via communication repeaters such as a router 41. The connection allows the devices to send and receive diverse kinds of information through the provider A 13.

A home appliance 42 at the user 11's home 12 is, for example, a personal computer or a TV receiver. The home appliance 42 has its space directory (SDR) 43 active. That is, the home appliance 42 is a typical information providing apparatus in which the space directory (SDR) 43 remains active.

The space directory (SDR) 43 active in the home appliance 42 contains information (i.e., device information) related to devices set up in a local space of the user 11's home 12. For example, the space directory (SDR) 43 accommodates device information including device IDs (identities), device names, device addresses (e.g., IP (Internet Protocol) address of each device), device functions, device owner information (e.g., address information about the personal directory (PDR) 45 of the user 11), and conditions for using devices (e.g., constraints on the user allowed to use a given device or the price to pay for using the device).

The space directory (SDR) 43 also contains Internet-related information including information about whether a given device is capable of connecting to the Internet 14, and information representing the settings for connecting to the Internet 14 (e.g., IP address, gateway address) if connection to the Internet 14 is available.

More specifically, if there is a TV receiver (e.g., home appliance 42) in the local space of the user 11's home 12, the space directory (SDR) 43 of the home appliance 42 holds the device ID of the TV receiver, functions of the TV receiver, information about the owner of the TV receiver, and conditions for using the TV receiver.

The space directory (SDR) 43 is active in one or a plurality of devices. In other words, one or a plurality of devices in the local space of the user 11's home 12 have an active space directory (SDR) 43 each. With this embodiment of the invention, the space directory (SDR) 43 that collectively stores device information is not mandatory; each device may retain its own device information that may be sent as needed to a mobile directory (MDR) 20 of a mobile adapter 19.

The personal computer 44 at the user 11's home 12 is connected via the router 41 to the provider A 13 to send and receive diverse kinds of information. The personal computer 44 has its personal directory (PDR) 45 active. That is, the personal computer 44 is a typical information providing apparatus in which the personal directory (PDR) 45 remains active.

The personal directory (PDR) 45 active in the personal computer 44 holds user-related information to be provided to the mobile directory (MDR) 20 in the mobile adapter 19 owned by a plurality of users. The user-related information kept in the personal directory (PDR) 45 is provided as needed to the mobile directory (MDR) 20 of the mobile adapter 19 owned by each user.

For example, the personal directory (PDR) 45 contains personal information such as the name of the user 11, the user 11's card number, the subscription ID of the chargeable broadcast to which the user 11 subscribes, and a password, as well as preference information (privacy-related information) such as subscription channels of the chargeable broadcast the user subscribes to. Part of the information (called subsets) held in the personal directory (PDR) 45 is provided as needed (i.e., upon request from the mobile adapter 19) to the mobile directory (MDR) 20 of the mobile adapter 19.

The provider A 13 constitutes a server provided by an Internet service provider under contract with the user 11. Diverse devices connected to the local network of the home 12 are connected to the Internet 14 via the router 41 and provider A 13.

The provider A 13, an ancestor directory server 15, and an Internet gateway 16 are connected to the Internet 14. Access to the Internet 14 is gained according to TCP/IP (Transmission Control Protocol/Internet Protocol) or some other suitable protocol. For example, a mobile phone 18 can access the Internet 14 for connection to the personal computer 44.

The ancestor directory server 15 acts in synchronism with the home appliances in which the space directory (SDR) is active. For example, the ancestor directory server 15 holds device IDs, device addresses, device functions, information about the device owner, and conditions for using the devices.

For example, the ancestor directory server 15 operates in conjunction with the space directory (SDR) 43 that is active in the home appliance 42, in order to acquire information associating the same device IDs as those in the space directory (SDR) 43 with the addresses of the corresponding devices. Upon request from a device connectable to the Internet 14, the ancestor directory server 15 provides the address of the device corresponding to the requested device ID. That is, the ancestor directory server 15 supplies the requesting device with the address of the desired device, allowing the requesting device to connect to the latter.

The Internet gateway 16 links the Internet 14 with a mobile phone network 17 and converts data between the two networks to ensure communications therebetween. The mobile phone network 17 is connected to mobile phones 18 and to the Internet 14 through the Internet gateway 16.

The mobile phone 18 is a typical communication apparatus connectable to the Internet 14. When connected to the Internet 14, the mobile phone 18 permits not only voice communication but also sending and reception of diverse kinds of data over the mobile phone network 17 and through the Internet gateway 16. The mobile phone 18, for example, has a connector as part of its communication unit 208, to be described later, the connector permitting connection with the mobile adapter 19.

The mobile directory (MDR) 20 is active in the mobile adapter 19. The mobile adapter 19 is a typical electronic device whose mobile directory (MDR) 20 remains active.

The mobile adapter 19, for example, has a connector as part of its communication unit 109, to be discussed later. The connector serves to connect the mobile phone 18 to the mobile adapter 19. With its adapter connected to the mobile phone 18, the mobile adapter 19 allows the mobile phone 18 to access the Internet 14 over the mobile phone network 17 and through the Internet gateway 16, whereby diverse kinds of information are sent and received. That is, the mobile adapter 19 controls the mobile phone 18 in a manner sending and receiving data to and from devices that can be connected to the Internet 14. The mobile adapter 19 also sends and receives information to and from other devices over a wireless LAN or through Bluetooth radio link-up. In the mobile adapter 19, the mobile directory (MDR) 20 remains active.

The mobile directory (MDR) 20 active in the mobile adapter 19 holds user-related information provided by the personal directory (PDR) 45. For example, the mobile directory (MDR) 20 accommodates personal information about the user 11 (e.g., a subscription ID and a password for the chargeable broadcast to which the user 11 subscribes) or privacy information about the user 11 (e.g., subscription channels of the chargeable broadcast under contract with the user 11). These kinds of information are provided by the personal directory (PDR) 45 active in the personal computer 44.

In an alternative structure, either of the above-described mobile phone 18 and mobile adapter 19 may be functionally integrated into the other device.

A home appliance 51 at a friend's home 21 is, for example, a personal computer or a TV receiver. The home appliance 51 cannot access the Internet 14 because it is not connected to an access point of the Internet 14. In other words, the home appliance 51 operates on a stand-alone basis. A space directory (SDR) 52 is active in the home appliance 51. For example, the home appliance 51 sends and receives information to and from other devices over a wireless LAN or through Bluetooth radio link-up. The home appliance 51 is a typical information providing apparatus whose space directory (SDR) remains active.

The location of the home appliance 51 is not limited to the friend's home 21. It may also be located in an office or other places where the user happens to be around.

The space directory (SDR) 52 holds information about devices (i.e., device information) set up in a local space of the friend's home 21. For example, the space directory (SDR) 52 accommodates device IDs, device functions, device owner information (e.g., address information about the device owner's personal directory (PDR), to be discussed later), and conditions for using devices (e.g., constraints on the user allowed to use a given device or the price to pay for using the device). More specifically, the space directory (SDR) 52 may hold device information about the TV receiver 53 located in the local area of the friend's home 21.

The space directory (SDR) 52 is active in one or a plurality of devices. In other words, one or a plurality of devices in the local space of the friend's home 21 have an active space directory (SDR) 52 each. With this embodiment of the invention, the space directory (SDR) 52 that collectively stores device information is not mandatory; each device may retain its own device information that may be sent as needed to the mobile directory (MDR) 20 of the mobile adapter 19.

FIG. 2 is a block diagram showing a typical structure of the mobile adapter 19.

A CPU (Central Processing Unit) 101 controls the mobile adapter 19 as a whole.

A ROM (Read Only Memory) 102 holds beforehand programs and data to be carried out or operated on by the CPU 101. A RAM (Random Access Memory) 103 accommodates as needed the programs and data being executed or operated on by the CPU 101.

A storage unit 104 is constituted, for example, by a hard disk drive or a flash memory that holds the programs and data for use by the CPU 101. For example, the storage unit 104 accommodates the mobile directory (MDR) 20 which in turn stores data such as personal information subsets. The storage unit 104 also holds authentication data about the user 11 (e.g., fingerprint data), and connection data, i.e., device ID of the device whose personal directory (PDR) is active (e.g., device ID of the personal computer 44 whose personal directory (PDR) is active) for connecting to the personal directory (PDR) 45. Part of the data to be held in the storage unit 104 may be placed in the ROM 102 or RAM 103.

The CPU 101, ROM 102, RAM 103, and storage unit 104 are interconnected by a bus 105.

An input/output interface 106 is connected to the CPU 101 through the bus 105. The input/output interface 106 is further connected to the communication units 107, 108 and 109; to a display unit 110, and to input units 111, 112 and 113.

The communication unit 107 has a sender 122 and a receiver 121 for sending and receiving diverse kinds of data respectively to and from other devices over a wireless LAN. For example, the communication unit 107 sends and receives data to and from the home appliance 51 in a wireless LAN setup.

More specifically, the sender 122 of the communication unit 107 in communication with the home appliance 51 on a wireless LAN basis broadcasts a request asking the home appliance 51 to detect the space directory (SDR) 52 (the request is called the SDR detection request hereinunder). The receiver 121 of the communication unit 107 communicating with the home appliance 51 over a wireless LAN receives the information that is held in the space directory (SDR) 52 and sent from the home appliance 51 (the received information is called the SDR information hereinunder).

The wireless LAN is a local area network (LAN) that permits wireless sending and reception of data in accordance with such communication standards as IEEE

(Institute of Electrical and Electronic Engineers)

802.11a or IEEE 802.11b.

The communication unit 108 has a sender 127 and a receiver 126 for sending and receiving diverse kinds of data respectively to and from other devices through Bluetooth radio link-up. For example, the communication unit 108 sends and receives data to and from the home appliance 51 in a Bluetooth radio link-up.

More specifically, the sender 127 of the communication unit 108 communicating with the home appliance 51 through Bluetooth radio link-up broadcasts an SDR detection request asking the home appliance 51 to detect the space directory (SDR) 52. The receiver 126 of the communication unit 108 in communication with the home appliance 51 in a Bluetooth radio link-up receives the SDR information that is held in the space directory (SDR) 52 and sent from the home appliance 51.

Bluetooth is a short-range wireless data communication technology that replaces cables and IrDA (an infrared data communication technology stipulated by the Infrared Data Association). For example, the Bluetooth technology involves sending and receiving data or audio information over a 2.45 GHz ISM (Industrial Scientific Medical) band. In a Bluetooth radio link-up, one master is connected to up to seven slaves communicating with each other at a sending speed of 721 Kbps for the output of 0 and 20 dBm. Bluetooth is a low-power, frequency-hopping (i.e., between the sender and the receiver) spread spectrum technology that utilizes high frequencies. As such, Bluetooth radio link-up are not subject to directivity-related constraints on the sending and reception of data or voice between the sender and the receiver.

The communication unit 109 is an interface (e.g., terminal) for interfacing with the mobile phone 18 (with its communication unit 208, to be more exact). The communication unit 109 has an input unit 131 and an output unit 132 for inputting and outputting diverse kinds of data. The communication unit 109 causes its output unit 132 and its input unit 131 to output or input data to or from the mobile phone 18 connected to the unit 109. For example, the communication unit 109 outputs control signals (e.g., commands) to the mobile phone 18 in order to connect the latter to the Internet 14. In other words, the mobile adapter 109 can access the Internet 14 through the mobile phone 18. Furthermore, the communication unit 109 admits data received by the mobile phone 18 over the Internet 14.

The display unit 110 is constituted by a LCD (Liquid Crystal Display) or the like. Diverse kinds of information are displayed on the display unit 110 in text or in image format.

The input unit 111 is made up of input switches, buttons, a keyboard, and/or a pointing device. For example, when the user 11 performs operations on the input unit 111, the input unit 111 sends corresponding signals to the CPU 101.

The input unit 112, for example, has an imaging device such as a CCD (Charge Coupled Device) sensor or a CMOS (Complementary Metal Oxide Semiconductor) sensor. Pictures taken of the subject by the imaging device are processed into picture data that is forwarded to the CPU 101.

The input unit 113 is constituted, for example, by a fingerprint reader that reads the fingerprint of the user 11. Based on the user 11's fingerprint thus read, the input unit 113 generates data necessary for biometric authentication (the generated data is called the fingerprint data hereinunder). The generated fingerprint data is supplied to a fingerprint data determination block 161, to be discussed later. The fingerprint data determination block 161 carries out biometric authentication based on the fingerprint data input from the input unit 113.

The fingerprint reader is part of the input unit 113. Instead of the fingerprint reader, the input unit 113 may be equipped with a suitable device for reading other biometric information than fingerprints such as physiognomic, iridic or DNA (deoxyribonucleic acid) patterns for biometric authentication. Alternatively, the input unit 113 may be furnished with a noncontact IC (Integrated Circuit) card reader-writer for reading data from a noncontact IC card for authentication purposes.

FIG. 3 is a block diagram showing a typical structure of a control program 151 executed by the CPU 101.

The control program 151 is held, for example, in the storage unit 104. The control program 151 is moved as needed from the storage unit 104 to the RAM 103 for execution by the CPU 101. For example, the control program 151 is loaded from the storage unit 104 into the RAM 103 and executed to determine whether there is an access point on the home network for connection to the Internet.

The control program 151 includes the fingerprint determination block 161, a network determination block 162, and a communication control block 163.

The fingerprint determination block 161 checks to determine whether the user 11's fingerprint data sent from the input unit 113 is valid. For example, the fingerprint determination block 161 determines the validity of the fingerprint data about the user 11 by comparing the fingerprint data coming from the input unit 113 with the fingerprint data kept beforehand in the storage unit 104 for coincidence.

The network determination block 162 checks to determine whether any device whose personal directory (PDR) is active is located on the same home network. The check is made based on the SDR information supplied from the receiver 121 of the communication unit 107 or from the receiver 126 of the communication unit 108, and on the device ID held in the storage unit 104 where the device ID identifies the device whose personal directory (PDR) is active.

For example, the network determination block 162 checks to determine whether the personal computer 44 with an active personal directory (PDR) 45 is on the same home network. The check is made by verifying whether the SDR information coming from the receiver 121 or 126 of the communication unit 107 or 108 includes a registered device ID matching that device ID in the storage unit 104 which identifies the personal computer 44 whose personal directory (PDR) is active.

In addition, the network determination block 162 checks to determine if there is an access point on the home network based on the SDR information sent from the receiver 121 or 126 of the communication unit 107 or 108. More specifically, the network determination block 162 determines the presence or absence of an access point on the home network based on the information which, as part of the SDR information coming from the receiver 126 of the communication unit 108, indicates whether access to the Internet 14 is available.

The communication control block 163 controls the communication units 107, 108 and 109 in a manner causing any one of the units to send and receive data.

For example, the communication control block 163 causes the communication unit 107 to send and receive data to and from other devices over a wireless LAN. The communication control block 163 also causes the communication unit 108 to send and receive data to and from other devices through Bluetooth radio link-up. Furthermore, the communication control block 163 causes the communication unit 109 to communicate with the mobile phone 18 so as to output and input data thereto and therefrom.

A control data generation block 164 generates data for displaying a list of communicable devices based on SDR information. The data thus generated is supplied to a display control block 165.

For example, the control data generation block 164 generates data for generating a list of devices communicable with the mobile adapter 19 based on the device type information as part of the received SDR information. The generated data is sent to the display control block 165, the data identifying, for example, a TV receiver 53 as a device communicable with the mobile adapter 19.

The control data generation block 164 generates user-specific operation menu data (control data) in response to the user's operations on the communicable device list appearing on the screen and in accordance with the SDR information as well as the information held in the mobile directory (MDR) 20. The user-specific operation menu data (control data) thus generated is forwarded to the display control block 165.

For example, suppose that the user 11's operation has selected the name of the TV receiver 53 displayed on a display unit 209 as a device communicable with the mobile telephone 18. In that case, the control data generation block 164 generates operation menu data specific to the user 11 based on the information about the TV receiver 53 received from the space directory (SDR) 52 of the home appliance 51, and on the information about the subscription channels of a chargeable broadcast held in the mobile directory (MDR) 20, the chargeable broadcast being under contract with the user 11. The control data generation block 164 then supplies the display control block 165 with the data representative of a list of channels available to the user 11 as the operation menu specific to the user 11.

The display control block 165 displays on the screen the data for displaying the list of communicable devices following sending of the data from the control data generation block 164. For example, the display control block 165 causes the display unit 209 of the mobile phone 18 to display the name of the TV receiver 53 based on the communicable device list display data supplied from the control data generation block 164.

The display control block 165 displays on the screen the data representing the user-specific operation menu data sent from the control data generation block 164. For example, the display control block 165 causes the display unit 209 of the mobile phone 18 to display a list of channels available to the user 11 in accordance with the user-specific operation menu data supplied from the control data generation block 164.

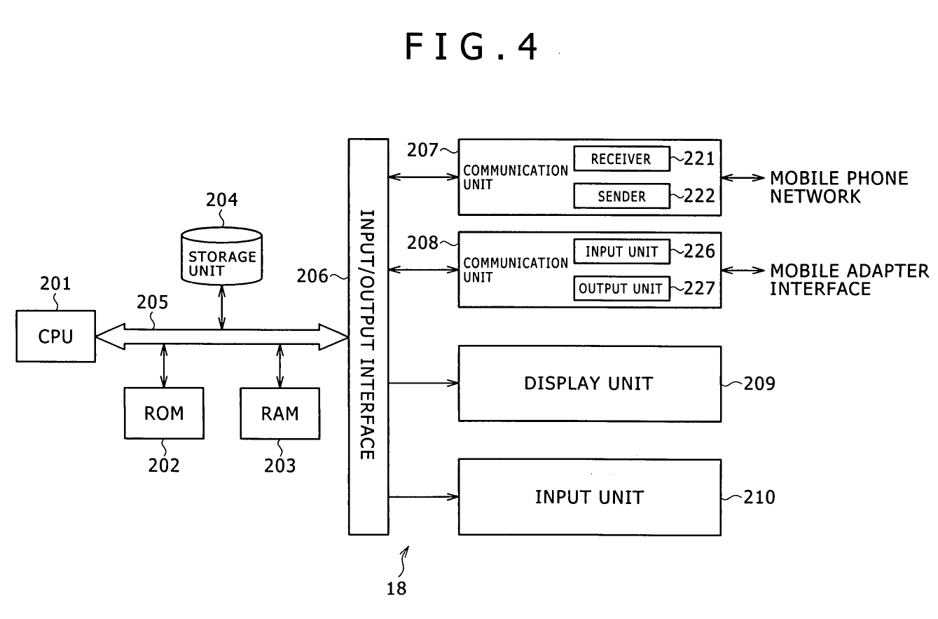

FIG. 4 is a block diagram showing a typical structure of the mobile phone 18.

Referring to FIG. 4, a CPU 201 controls the mobile phone 18 as a whole.

A ROM 202 holds beforehand programs and data to be executed or operated on by the CPU 201. A RAM 203 accommodates as needed the programs and data being executed and operated on by the CPU 201.

A storage unit 204 is constituted, for example, by a hard disk drive or a flash memory that holds programs and data to be executed or operated on by the CPU 201. Part of the data to be held in the storage unit 204 may be placed in the ROM 202 or RAM 203.

The CPU 201, ROM 202, RAM 203, and storage unit 204 are interconnected by a bus 205.

An input/output interface 206 is connected to the CPU 201 through the bus 205. The input/output interface 206 is further connected to communication units 207 and 208 as well as to the display unit 209 and an input unit 210.

The communication unit 207 sends and receives voice data to and from the mobile phone network 17 via a base station, not shown. At times of communication, the communication unit 207 sends and receives diverse kinds of data via the base station over the mobile phone network 17, through the Internet gateway 16, and on the Internet 14. The communication unit 207 has a receiver 221 and a sender 222 for receiving and sending the data.

The communication unit 208 is an interface (e.g., terminal) for interfacing with the mobile adapter 19 (with its communication unit 109, to be more exact). The communication unit 208 has an input unit 226 and an output unit 227 for inputting and outputting diverse kinds of data. When connected to the communication unit 109 of the mobile adapter 19, the communication unit 208 outputs or inputs data to or from the mobile adapter 19 through the communication unit 109.

For example, the communication unit 208 acts on control signals (e.g., commands) input from the mobile adapter 19 to access the Internet 14 for data sending over the mobile phone network 17 and through the Internet gateway 16. That is, the mobile phone 18 under control of the mobile adapter 19 establishes connection with the Internet 14 over the mobile phone network 17 and via the Internet gateway 16. Furthermore, the mobile phone 18 outputs to the mobile adapter 19 the data received through connection with the Internet 14 over the mobile phone network 17 and via the Internet gateway 16.

The display unit 209 is constituted by a LCD or the like. Diverse kinds of information are displayed on the display unit 209 in text or in image format.

The input unit 210 is made up of input switches, buttons, a keyboard, and/or a pointing device. For example, when the user 11 performs operations on the input unit 210, the unit 210 sends corresponding signals to the CPU 201.

FIG. 5 is a block diagram showing a typical structure of the home appliance 42.

Referring to FIG. 5, a wireless communication unit 301 has a sender 312 and a receiver 311 for sending and receiving diverse kinds of data, as well as an interface for interfacing with other devices over a wireless LAN or through Bluetooth radio link-up or infrared data communication links. The wireless communication unit 301 uses one of these communication systems to establish connection with other devices for data sending and reception.

For example, the wireless communication unit 301 communicates with the mobile adapter 19 through Bluetooth radio link-up for data sending and reception. More specifically, the receiver 311 of the wireless communication unit 301 communicating with the mobile adapter 19 in a Bluetooth radio link-up receives an SDR detection request from the mobile adapter 19 requesting detection of the space directory (SDR) 43. The received SDR detection request is forwarded to a system control unit 303. The sender 312 of the wireless communication unit 301 sends to the mobile phone 19 the SDR information that is kept in the space directory (SDR) 43 supplied from the system control unit 303.

A wired communication unit 302 has a sender 317 and a receiver 316 for sending and receiving diverse kinds of data, as well as an interface for interfacing with a wired LAN such as the Ethernet (registered trademark). The wired communication unit 302 communicates with other devices over a wired network for data sending and reception. For example, the wired communication network 302 connects to the personal computer 44 over a local network at the user's home 12 for sending and receiving data to and from the PC 44.

The system control unit 303 controls the home appliance 42 as a whole. For example, the system control unit 303 reads SDR information from the space directory (SDR) 43 in a storage unit 304 based on an SDR detection request coming from the wireless communication unit 301. The SDR information thus read out is forwarded to the wireless communication unit 301. In turn, the wireless communication unit 301 sends the SDR information to the mobile adapter 19.

The storage unit 304 is constituted, for example, by a nonvolatile memory such as an EEPROM (Electronically Erasable and Programmable Read Only Memory) or a flash memory or by a hard disk drive. The storage unit 304 holds in advance the programs and data to be executed and operated on by the system control unit 303. For example, the storage unit 304 accommodates the programs and data necessary for activating the space directory (SDR) 43. That is, the storage unit 304 is supplied with diverse kinds of device information (e.g., user setting information) to be fed to the space directory (SDR) 43. The supplied information is forwarded as needed to the space directory (SDR) 43 and stored therein as SDR information.

FIG. 6 is a block diagram showing a typical structure of the home appliance 51.

Referring to FIG. 6, a wireless communication unit 351 has a sender 362 and a receiver 361 for sending and receiving diverse kinds of data, as well as an interface for interfacing with other devices over a wireless LAN or through Bluetooth radio link-up or infrared data communication links. The wireless communication unit 351 uses one of these communication systems to establish connection with other devices for data sending and reception.

For example, the wireless communication unit 351 communicates with the mobile adapter 19 through Bluetooth radio link-up for data sending and reception. More specifically, the receiver 361 of the wireless communication unit 351 communicating with the mobile adapter 19 in a Bluetooth radio link-up receives an SDR detection request from the mobile adapter 19 requesting detection of the space directory (SDR) 52. The received SDR detection request is forwarded to a system control unit 354. The sender 362 of the wireless communication unit 351 sends to the mobile phone 19 the SDR information that is kept in the space directory (SDR) 52 supplied from the system control unit 354.

An input unit 352 is typically made up of switches, buttons, a keyboard, and/or a mouse. Signals input to the input unit 352 are forwarded to the system control unit 354. An output unit 353 is constituted, for example, by a display device such as a CRT (Cathode Ray Tube), a LCD and/or speakers. As such, the output unit 353 outputs signals that are supplied from the system control unit 354.

The system control unit 354 controls the home appliance 51 as a whole. For example, the system control unit 354 reads data from the space directory (SDR) 52 in a storage unit 355 based on a request coming from the wireless communication unit 351 requesting detection of the space directory (SDR) 52. The data thus read out is forwarded to the wireless communication unit 351. In turn, the wireless communication unit 351 sends the data to the mobile adapter 19.

The storage unit 355 is constituted, for example, by a nonvolatile memory such as an EEPROM or a flash memory or by a hard disk drive. The storage unit 355 holds in advance the programs and data to be executed and operated on by the system control unit 354. For example, the storage unit 355 accommodates the programs and data necessary for activating the space directory (SDR) 52. That is, the storage unit 355 is supplied with diverse kinds of device information (e.g., user setting information) to be fed to the space directory (SDR) 52. The supplied information is forwarded as needed to the space directory (SDR) 52 and stored therein as SDR information.

FIG. 7 is a block diagram showing a typical structure of the personal computer 44.

Referring to FIG. 7, a CPU 401 carries out various processes in keeping with programs held in a ROM 402 or stored in a storage unit 408. A RAM 403 accommodates as needed the programs and data being executed or operated on by the CPU 401. The CPU 401, ROM 402, and RAM 403 are interconnected by a bus 404.

An input/output interface 405 is connected to the CPU 401 through the bus 404. The input/output interface 405 is further connected to an input unit 406 made up of a keyboard and a mouse, as well as to an output unit 407 such as a display device. The CPU 401 performs diverse processes in response to commands coming from the input unit 406. Pictures and sounds resulting from the processing are output from the CPU 401 to the output unit 407.

The storage unit 408 connected to the input/output interface 405 is constituted, for example, by a hard disk drive that holds programs and diverse data to be executed or operated on by the CPU 401. For example, the storage unit 408 accommodates the programs and data necessary for activating the personal directory (PDR) 45. That is, the storage unit 408 accommodates various items of personal information (e.g., name or card number of the user 11) or privacy information (e.g., preference information about the user 11). These items of information are sent as needed to the personal directory (PDR) 45 for storage therein (the information is called the PDR information).

A communication unit 409 has a sender 432 and a receiver 431 for sending and receiving diverse kinds of data, as well as an interface for interfacing with other devices over a wireless LAN or through Bluetooth radio link-up or infrared data communication links. The communication unit 409 uses one of these communication systems to establish connection with other devices for data sending and reception. For example, the communication unit 409 communicates with the mobile adapter 19 in a Bluetooth radio link-up for data sending and reception.

More specifically, the receiver 431 of the communication unit 409 communicating with the mobile adapter 19 through Bluetooth radio link-up receives a request from the mobile adapter 19 requesting acquisition of the personal directory (PDR) 45 (the request is called the PDR acquisition request). The received PDR acquisition request is forwarded to the CPU 401. The sender 432 of the communication unit 409 sends to the mobile phone 19 the PDR information that is kept in the personal directory (PDR) 45 supplied from the CPU 401.

A communication 410 has a sender 437 and a receiver 436 for sending and receiving diverse kinds of data to and from other devices through a communication network, the Internet 14 or some other suitable network or via appropriate communication media.

More specifically, the receiver 436 of the communication unit 410 receives a PDR acquisition request from the mobile phone 19 requesting acquisition of the personal directory (PDR) 45. The request is sent via the mobile phone network 17, Internet gateway 16, the Internet 14, provider A 13, and router 41. The received PDR acquisition request is forwarded to the CPU 401. The sender 437 of the communication unit 410 sends the PDR information held in the personal directory (PDR) 45 received from the CPU 401 to the mobile phone 18 through the router 41, provider A 13, the Internet 14, Internet gateway 16, and mobile phone network 17. Programs may also be acquired through the communication unit 410 and recorded to the storage unit 408.

A magnetic disk 421, an optical disk 422, a magneto-optical disk 423, or a semiconductor memory 424 may be loaded into a drive 411 connected to the input/output interface 405. When loaded with any of these recording media, the drive 411 acquires programs or data from the recording medium driven thereby. The acquired programs and data are transferred as needed to the storage unit 408 for storage therein.

The ancestor directory server 15 has the same structure as the personal computer 44 and thus will not be discussed further.

The devices described structurally above with reference to FIGS. 5 through 7 are examples that may be found at the user's home 12 as well as at the friend's home 21. These structures may be adopted by diverse kinds of devices set up in such places, including personal computers, TV receivers, printers or telephones. The structures may be suitably arranged when applied to any of the devices in question. For example, the home appliance 42 may have the structure of FIG. 6 or 7, and the home appliance 51 may adopt the structure of FIG. 5 or 7.

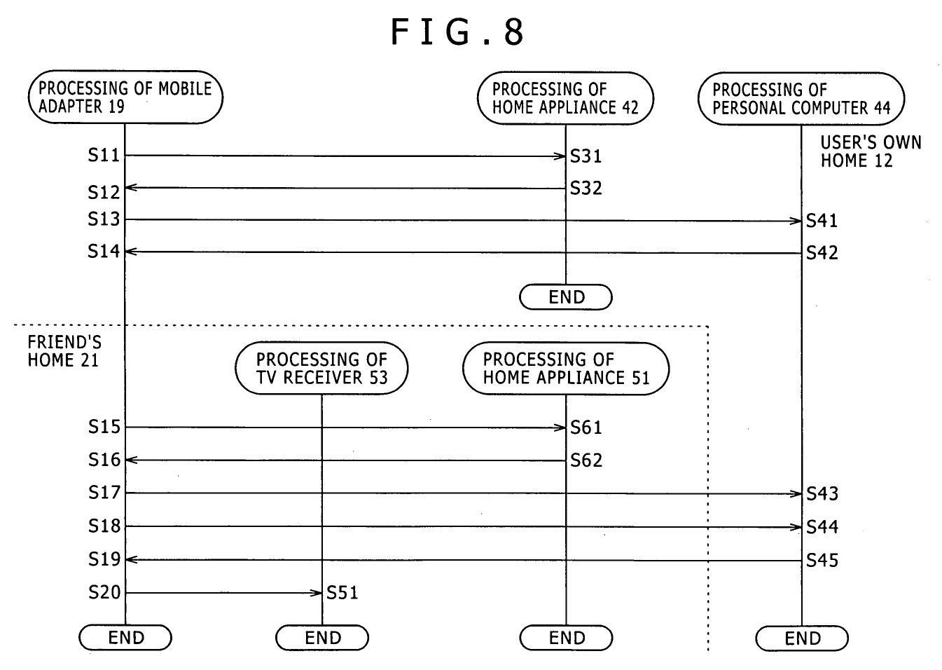

FIG. 8 is a sequence diagram outlining overall processing of the communication system 1 in FIG. 1. The sequence diagram in FIG. 8 shows what takes place, as an example of the processing of the inventive communication system 1, when the user 11 views a chargeable broadcast he or she subscribes to on the TV receiver 53 of the friend's home 21.

In the sequence diagram of FIG. 8, steps S11 through S14, steps S31 and S32, and steps S41 through S45 constitute processes performed in the user 1's home 12; steps S15 through S20, step S51, and steps S61 and S62 represent processes carried out when the user 11 is at the friend's home 21. In other words, the processing at the user's home 12 is distinguished by broken lines in FIG. 8 from the processing at the friend's home 21.

What takes place when the user is at the user's own home 12 will now be described. The user 11 is in possession of the mobile phone 18 to which the mobile adapter 19 is connected. The device ID of the personal computer 44 whose personal directory (PDR) 45 is active at the home 12 and the fingerprint information about the user 11 are recorded beforehand in the mobile adapter 19. At the home 12, the user 11 performs fingerprint authentication preparatory to using the mobile adapter 19. If the fingerprint authentication is successful, step S11 is reached.

In step S11, the mobile adapter 19 establishes communication with nearby devices, for example, through Bluetooth radio link-up and broadcasts an SDR detection request asking detection of the space directory (SDR) 43.

In step S31, the home appliance 42 whose space directory (SDR) 43 is active communicates with the mobile adapter 19, for example, through Bluetooth radio link-up and receives the SDR detection request broadcast by the mobile adapter 19. That is, the home appliance 42 is one of the devices receiving the SDR detection request broadcast by the mobile adapter 19.

In step S32, the home appliance 42 in communication with the mobile adapter 19 through Bluetooth radio link-up responds to the SDR detection request from the mobile adapter 19 by sending the SDR information (e.g., device information) from the space directory (SDR) 43 to the mobile adapter 19.

FIG. 9 is a tabular view showing typical SDR (space directory) information held in the space directory (SDR) 43 active in the home appliance 42. The SDR information may include, say, the device type, device name, commands, and receivable channels regarding each device.

For example, the SDR information shown in FIG. 9 has the device type “TV receiver” and the device name “TV-1” stored in conjunction with a command “0x0001” for a free channel “1,” a command “0x0002” for a free channel “3,” a command “0x0003” for a free channel 4, a command “0x0004” for a free channel 6, a command “0x0005” for a free channel 8, a command “0x0006” for a free channel 10, and a command “0x0007” for a free channel 12. The SDR information also includes a command “0x0010” for a chargeable channel called “Casper TV 1.”

In step S12 back in FIG. 8, the mobile adapter 19 in communication with the home appliance 42 through Bluetooth radio link-up receives the SDR information from the home appliance 42. More specifically, the mobile adapter 19 communicating with the home appliance 42 in a Bluetooth radio link-up receives the SDR information shown in FIG. 9 from the appliance 42 in step S12.

In step S13, the mobile adapter 19 communicates, for example, with the personal computer 44 in a Bluetooth radio link-up based on the SDR information received from the home appliance 42 and on an internally stored device ID of the personal computer 44 in which the personal directory (PDR) 45 is active. In so doing, the mobile adapter 19 sends a PDR acquisition request to the personal computer 44 requesting acquisition of the personal directory (PDR) 45.

More specifically, the SDR information received from the home appliance 42 reveals that the information contains a device ID matching the internally stored device ID of the personal computer 44 whose personal directory (PDR) 45 is active. That means there exists on the local network of the user's home 12 the personal computer 44 in which the personal directory (PDR) 45 is active. In that case, based on the device ID of the personal computer 44, the mobile adapter 19 sends a PDR acquisition request to the personal computer 44 requesting acquisition of the personal directory (PDR) 45.

In step S41, the personal computer 44 whose personal directory (PDR) 45 is active receives the PDR acquisition request from the mobile adapter 19, for example, through Bluetooth radio link-up.

In step S42, in response to the PDR acquisition request received from the mobile adapter 19 through Bluetooth radio link-up, the personal computer 44 sends to the mobile adapter 19 part of the PDR information (i.e., subsets) held in the personal directory (PDR) 45. For example, the personal computer 44 in step S42 responds to the PDR acquisition request from the mobile adapter 19 by sending to the mobile adapter 19 personal information about the user 11 as part of the PDR information (e.g., subscription ID and password for the chargeable broadcast to which the user 11 subscribes).

FIG. 10 is a tabular view showing typical PDR information in the personal directory (PDR) 45 active in the personal computer 44. The PDR information shown in FIG. 10 is described in XML (extensible Markup Language).

The first line of the PDR information in FIG. 10 has a tag indicating that the PDR information that follows is described in XML version 1.0. The PDR information begins with a name tag followed by a device type tag.

Between a start and an end tag representative of the name tag in the PDR information shown in FIG. 10, there comes a text “USER 11” indicating that the user's name is the user 11.

Between a start and an end tag representative of the device type tag in the PDR information shown in FIG. 10, there are a device type name tag, an available channel tag, and a subscription broadcast tag.

In the PDR information shown in FIG. 10, a first device type name tag under the device type tag describes information about the device type name given in text form “TV RECEIVER,” indicating that the device type name is the TV receiver.

The device type name tag is followed by the available channel tag given in text form, “4, 6, 8, 10, 12,” indicating the channels freely available to the user.

Between a start and an end tag representative of the subscription broadcast tag in the PDR information shown in FIG. 10, there are a chargeable broadcast name tag, a subscription ID tag, a password tag, and a subscription channel tag.

In the PDR information shown in FIG. 10, a first chargeable broadcast name tag under the subscription broadcast tag is given in text form “Casper TV 1,” indicating that the chargeable broadcast name is Casper TV 1.

The chargeable broadcast name tag is followed by the subscription ID tag given in text form “xxxxx,” indicating the subscription ID for the chargeable broadcast to which the user subscribes.

The subscription ID tag is followed by the password tag given in text form “yyyyy,” indicating the password for the subscription ID of the chargeable broadcast to which the user subscribes.

The password tag is followed by the subscription channel tag given in text form, “SOCCER” and “DRAMAS,” indicating the subscription channels of the chargeable broadcast to which the user subscribes.

In step S14 back in step FIG. 8, the mobile adapter 19 communicating with the personal computer 44, for example, through Bluetooth radio link-up receives subsets of the PDR information from the personal computer 44. The mobile adapter 19 stores the received PDR information subsets into the mobile directory (MDR) 20. More specifically, the mobile adapter 19 receives the PDR information shown in FIG. 10 from the personal computer 44 while in communication with the personal computer 44 through Bluetooth radio link-up, and places the received PDR information into the mobile directory (MDR) 20.

That is, the mobile directory (MDR) 20 active in the mobile adapter 19 now accommodates the PDR information shown in FIG. 10 and received from the personal computer 44, the received information specifying the license of the chargeable broadcast to which the user 11 subscribes (i.e., subscription ID “xxxxx” and password “yyyyy” for the chargeable broadcast named “Casper TV 1”), as well as the subscription channels of the chargeable broadcast (i.e., subscription channels “SOCCER” and “DRAMAS”).

The user 11 in possession of the mobile phone 18 to which the mobile adapter 19 is attached then moves from the user's home 12 to the friend's home 21. Below is a description of what takes place in the friend's home 21.

In step S15, the communication unit 207 of the mobile adapter 19 establishes communication with nearby devices, for example, through Bluetooth radio link-up and broadcasts an SDR detection request asking detection of the space directory (SDR) 52.

In step S61, the home appliance 51 whose space directory (SDR) 52 is active communicates with the mobile adapter 19, for example, through Bluetooth radio link-up and receives the SDR detection request broadcast by the mobile adapter 19. That is, the home appliance 51 is one of the devices receiving the SDR detection request broadcast by the mobile adapter 19.

In step S62, the home appliance 51 in communication with the mobile adapter 19 through Bluetooth radio link-up responds to the SDR detection request from the mobile adapter 19 by sending the SDR information to the mobile adapter 19.

FIG. 11 is a tabular view showing typical SDR (space directory) information held in the space directory (SDR) 52 active in the home appliance 51. The SDR information may include, say, the device type, device name, commands, and receivable channels regarding each device.

For example, the SDR information shown in FIG. 11 has the device type “TV receiver” and the device name “TV-1” stored in conjunction with the command “0x0001” for the free channel “1,” command “0x0002” for the free channel “3,” command “0x0003” for the free channel 4, command “0x0004” for the free channel 6, command “0x0005” for the free channel 8, command “0x0006” for the free channel 10, and command “0x0007” for the free channel 12.

The SDR information also includes the command “0x0010” for the chargeable channel called “Casper TV 1,” a command “0x0011” for a chargeable channel called “Casper TV 2,” and a command “0x0012” for a chargeable channel called “DAI-NIPPON CABLE TV.”

In step S16 back in FIG. 8, the mobile adapter 19 in communication with the home appliance 51 through Bluetooth radio link-up receives the SDR information from the home appliance 51. More specifically, the mobile adapter 19 communicating with the home appliance 51 in a Bluetooth radio link-up receives the SDR information shown in FIG. 11 from the appliance 51 in step S16.

The received SDR information shown in FIG. 11 reveals that the friend's home 21 has the TV receiver 53 and that the TV receiver 53 is capable of receiving the freely available channels “1,” “3,” “4,” “6,” “8,” “10,” and “12,” as well as the chargeable channels “Casper TV 1,” “Casper TV 2,” and “Dai-Nippon Cable TV.”

In step S17, the mobile adapter 19 causes the mobile phone 18 to access the Internet 14 through the mobile phone network 17 and Internet gateway 16 based on the SDR information received from the home appliance 51 and on an internally stored device ID of the personal computer 44 in which the personal directory (PDR) 45 is active. When connected to the Internet 14, the mobile phone 18 sends the SDR information (device information) supplied from the mobile adapter 19 to the personal computer 44 through the mobile phone network 17, Internet gateway 16, the Internet 14, provider A 13, and router 41.

For example, in step S17, the mobile phone 18 connected to the Internet 14 selects information about the TV receiver 53 as a device communicable with the mobile adapter 19, out of the SDR information supplied from the mobile adapter 19, and sends the selected information to the personal computer 44 through the mobile phone network 17, Internet gateway 16, the Internet 14, provider A 13, and router 41.

More specifically, the SDR information received from the home appliance 51 tells the mobile adapter 19 that the information does not contain a device ID matching the internally stored device ID of the personal computer 44 whose personal directory (PDR) 45 is active. That means there does not exist on the local network of the friend's home 21 the personal computer 44 in which the personal directory (PDR) 45 is active. The SDR information also includes information indicating that the home appliance 51 is not capable of accessing the Internet 14. In that case, the mobile adapter 19 causes the mobile phone 18 to access the Internet 14 in order to send a PDR acquisition request to the personal computer 44.

Address information necessary for connecting to the personal computer 44 may be stored beforehand in conjunction with the device ID as part of the SDR information for subsequent acquisition. Alternatively, the address information corresponding to the device ID of the personal computer 44 may be acquired by way of the ancestor directory server 15 connected to the Internet 14.

In other words, when the home appliance 51 whose space directory (SDR) 52 is active is incapable of accessing the Internet (i.e., there is no Internet access point), the mobile adapter 19 causes the mobile phone 18 to access the Internet 14 through the mobile phone network 17 and Internet gateway 16. When thus connected to the Internet 14, the mobile phone 18 sends the SDR information (device information) to the personal computer 44 through the mobile phone network 17, Internet gateway 16, the Internet 14, provider A 13, and router 41.

In step S43, the personal computer 44 receives the device information about the home appliance 51 from the mobile phone 18 through the mobile phone network 17, Internet gateway 16, the Internet 14, provider A 13, and router 41. In turn, the personal computer 44 stores the SDR information (device information) received from the mobile adapter 19 into the personal directory (PDR) 45 together with a timestamp.

For example, the personal computer 44 receives information about the TV receiver 53 as a device communicable with the mobile adapter 19 through the mobile phone network 17, Internet gateway 16, the Internet 14, provider A 13, and router 41. The received information about the TV receiver 53 is stored into the personal directory (PDR) 45 along with a timestamp.

As described, the personal computer 44 receives device information from the mobile adapter 19 and stores the received device information into the personal directory (PDR) 45. That means the personal directory (PDR) 45 always accommodates device information about the devices which are located near the mobile adapter 19 owned by the user 11 and which are capable of communicating with the mobile adapter 19. In the above example, the personal directory (PDR) 45 holds the information about the TV receiver 53 which is located close to the user 11's mobile adapter 19 and which can communicate with the mobile adapter 19.

In the case above, the mobile adapter 19 causes the display unit 209 of the mobile phone 18 to display a list of devices communicable with the mobile adapter 19 in accordance with the received SDR information. For example, based on the device type in the received SDR information shown in FIG. 11, the mobile adapter 19 displays on the display unit 209 of the mobile phone 19 the name of the TV receiver 53 as a device capable of communicating with the mobile adapter 19.

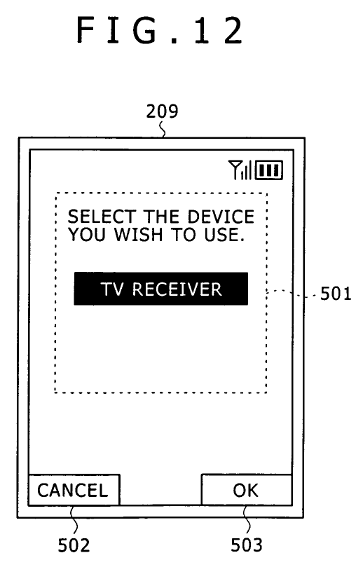

FIG. 12 is a schematic view of a typical display screen on the display unit 209 of the mobile phone 18 displaying the names of devices communicable with the mobile adapter 19. In the example of FIG. 12, an explanatory text such as “SELECT THE DEVICE YOU WISH TO USE” is shown appearing in an area 501 on the display unit 209 of the mobile phone 18. Also displayed is the name “TV RECEIVER” as a device capable of communicating with the mobile adapter 19. That is, the example of FIG. 12 shows that because the SDR information in FIG. 11 contains only the name of the TV receiver 53, the area 501 of the display unit 209 displays only “TV RECEIVER” as the device that can communicate with the mobile adapter 19. The display unit 209 further displays a cancel button 502 and an OK button 503.

In step S18 back in step FIG. 8, the mobile adapter 19 causes the mobile phone 18 to access the Internet 14 through the mobile phone network 17 and Internet gateway 16 based on the SDR information received from the home appliance 51 and on an internally stored device ID of the personal computer 44 in which the personal directory (PDR) 45 is active. When connected to the Internet 14, the mobile phone 18 sends a PDR acquisition request to the personal computer 44 through the mobile phone network 17, Internet gateway 16, the Internet 14, provider A 13, and router 41.

For example, in step S18, the mobile adapter 19 allows the user 11 to perform operations for selecting the name of the TV receiver 53 on the display unit 209 of the mobile phone 18 and to press the OK button 503. This causes the mobile phone 18 to access the Internet 14 through the mobile phone network 17 and Internet gateway 16 and to send a PDR acquisition request to the personal computer 44 in order to acquire information not found in the mobile directory (MDR) 20, based on the SDR information received from the home appliance 51 and on the internally stored device ID of the personal computer 44 in which the personal directory (PDR) 45 is active.

In other words, the mobile adapter 19 connects the mobile phone 18 to the Internet 14 through the mobile phone network 17 and Internet gateway 16 so as to acquire information not found in the mobile directory (MDR) 20. When thus connected to the Internet 14, the mobile phone 18 sends to the personal computer 44 a PDR acquisition request requesting acquisition of information not included in the mobile directory (MDR) 20 from the personal directory (PDR) 45. The request is sent to the personal computer 44 through the mobile phone network 17, Internet gateway 16, the Internet 14, provider A 13, and router 41.

For example, the mobile phone 18 connected to the Internet 14 sends to the personal computer 44 the PDR acquisition request requesting the acquisition from the personal directory (PDR) 45 of the information about the subscription channels of the chargeable broadcast to which the user 11 subscribes, the information being absent in the mobile directory (MDR) 20. The request is sent to the personal computer 44 through the mobile phone network 17, Internet gateway 16, the Internet 14, provider A 13, and router 41.

In step S44, the personal computer 44 receives the PDR acquisition request from the mobile phone 18. For example, the personal computer 44 in step S44 receives from the mobile phone 18 the PDR acquisition request asking acquisition of the subscription channels of the chargeable broadcast under contract with the user 11.

FIG. 13 is a tabular view showing another typical PDR information held in the personal directory (PDR) 45 active in the personal computer 44. The PDR information shown in FIG. 13 is described in XML as in the case of the information described in FIG. 10.

In FIG. 13, those parts of the PDR information which have already been discussed with reference to FIG. 10 will not be described further.

A subscription channel tag describes in text form, “SOCCER,” “DRAMAS,” “MOVIES” and “GOLF,” the subscription channels of the chargeable broadcast to which the user subscribes.

In the example of FIG. 13, the subscription channels in the PDR information described above in FIG. 10 are supplemented with more channels named “MOVIES” and “GOLF.” That is, after the PDR information is stored into the mobile directory (MDR) 20 in step S14, the user 11 has subscribed anew to the movie and golf channels of the chargeable broadcast “Casper TV.” In other words, the number of subscription channels of “Casper TV 1” to which the user 11 subscribes has been raised from two (“SOCCER” and “DRAMAS”) to four (“SOCCER,” “DRAMAS,” “MOVIES” and “GOLF,”).

In step S45 back in FIG. 8, the personal computer 44 sends PDR information subsets to the mobile phone 18 through the router 41, provider A 13, the Internet 14, Internet gateway 16, and mobile phone network 17 in response to the PDR acquisition request received from the mobile phone 18.

For example, in step S42, the personal computer 44 sends subscription channel information (representative of the subscription channels “MOVIES” and “GOLF”) about the user 11 as the PDR information to the mobile phone 18 through the router 41, provider A 13, the Internet 14, Internet gateway 16, and mobile phone network 17. That is, of the PDR information shown in FIG. 13, only the extra data part not found in the PDR information described in FIG. 10 (i.e., subscription channels “MOVIES” and “GOLF”) is sent to the mobile phone 18.

In step S19, the mobile adapter 19 acquires the PDR information subsets that have been received by the mobile phone 18 from the personal computer 44. The mobile adapter 19 stores the acquired PDR information subsets into the mobile directory (MDR) 20.

For example, the mobile adapter 19 acquires the subscription channel information (i.e., subscription channels “MOVIES” and “GOLF”) about the user 11 as the PDR information subsets received by the mobile phone 18 from the personal computer 44. The received subscription channel information about the user 11 is placed into the mobile directory (MDR) 20.

In other words, the mobile directory (MDR) 20 accommodates the PDR information described in FIG. 10 (i.e., subscription channels “SOCCER” and “DRAMAS”) plus the extra data added anew to the PDR information shown in FIG. 13 (i.e., subscription channels “MOVIES” and “GOLF”). As a result, the mobile directory (MDR) 20 retains the same PDR information as that shown in FIG. 13 (including the subscription channels “SOCCER,” “DRAMAS,” “MOVIES” and “GOLF”).

At this point, the mobile adapter 19 generates operation menu data specific to the user based on the SDR information received from the space directory (SDR) 52 of the home appliance 51 and on the information held in the mobile directory (MDR) 20 of the mobile adapter 19.

FIG. 14 is a tabular view showing a typical structure of a user-specific operation menu. The operation menu shown in FIG. 14 is described structurally in XML as in the case of the information described in FIG. 10.

The first line of the operation menu structure in FIG. 14 has a tag indicating that the PDR information that follows is described in XML version 1.0.

The operation menu begins with a name tag followed by a device type tag.

Between a start and an end tag representative of the name tag in the operation menu shown in FIG. 14, there comes a text “USER 11” indicating that the user's name is the user 11.

Between a start and an end tag representative of the device type tag in the operation menu shown in FIG. 14, there are a device type name tag, a free broadcast tag, and a subscription broadcast tag.

In the operation menu shown in FIG. 14, a first device type name tag under the device type tag describes information about the device type name given in text form “TV RECEIVER,” indicating that the device type name is the TV receiver.

The device type name tag is followed by the free broadcast tag. Between a start and an end tag representative of the free broadcast tag, there are available channel tags.

In the operation menu structure shown in FIG. 14, a first available channel tag describes information about a freely available channel in text form “4.” The channel name tag is followed by a command in text form “0x0003” which is sent to the TV receiver when the channel name “4” is selected.

A second available channel tag describes information about another freely available channel in text form “6.” The channel name tag is followed by a command in text form “0x0004” which is sent to the TV receiver when the channel name “6” is selected. A third available channel tag describes information about a further freely available channel in text form “8.” The channel name tag is followed by a command in text form “0x0005” which is sent to the TV receiver when the channel name “8” is selected.

A fourth available channel tag describes information about an even further freely available channel in text form “10.” The channel name tag is followed by a command in text form “0x0006” which is sent to the TV receiver when the channel name “10” is selected. A fifth available channel tag describes information about a still further freely available channel in text form “12.” The channel name tag is followed by a command in text form “0x0007” which is sent to the TV receiver when the channel name “12” is selected.

In the operation menu structure shown in FIG. 14, the free broadcast tag is followed by the subscription broadcast tag. Between a start and an end tag representative of the subscription broadcast tag, there are chargeable broadcast name tags, a display tag, a subscription ID tag, a password tag, and subscription channel tags.

In the operation menu structure shown in FIG. 14, a first chargeable broadcast name tag under the subscription broadcast tag is given in text form “Casper TV 1,” indicating that the chargeable broadcast name is Casper TV 1.

The chargeable broadcast name is followed by the display tag. The display tag is given as a command in text form “0x0010.”

The display tag is followed by the subscription ID tag. The subscription ID tag is given in text form “xxxxx,” indicating the subscription ID of the chargeable broadcast to which the user subscribes.

The subscription ID tag is followed by the password tag. The password tag is given in text form “yyyyy,” indicating the password associated with the subscription ID of the chargeable broadcast to which the user subscribes.

The password tag is followed by the subscription channel tags. A first subscription channel tag is given in text form “SOCCER,” indicating one subscription channel of the chargeable broadcast to which the user subscribes. The channel name tag is followed by a command in text form “0x0101” which is sent to the TV receiver when the channel name “SOCCER” is selected. A second subscription channel tag is given in text form “DRAMAS,” indicating another subscription channel of the chargeable broadcast. The channel name tag is followed by a command in text form “0x0102” which is sent to the TV receiver when the channel name “DRAMAS” is selected.

A third subscription channel tag is given in text form “MOVIES,” indicating a further subscription channel of the chargeable broadcast. The channel name tag is followed by a command in text form “0x0103” which is sent to the TV receiver when the channel name “MOVIES” is selected. A fourth subscription channel tag is given in text form “GOLF,” indicating an even further subscription channel of the chargeable broadcast. The channel name tag is followed by a command in text form “0x0104” which is sent to the TV receiver when the channel name “GOLF” is selected.

As described, the operation menu structure in FIG. 14 is generated based on the SDR information (shown in FIG. 11) received from the space directory (SDR) 52 of the home appliance 51 and on the information held in the mobile directory (MDR) 20 of the mobile adapter 19 (i.e., PDR information shown in FIG. 13).

The mobile adapter 19 displays on the screen the generated user-specific data representative of the operation menu. More specifically, the mobile adapter 19 causes the display unit 209 of the mobile phone 18 to display a list of channels available to the user 11 as a user-specific operation menu.

For example, the mobile adapter 19 causes the display unit 209 of the mobile phone 18 to display a list of available channels based on the operation menu structure described in FIG. 14. This is an operation menu prepared specifically for the user 11 to operate on.

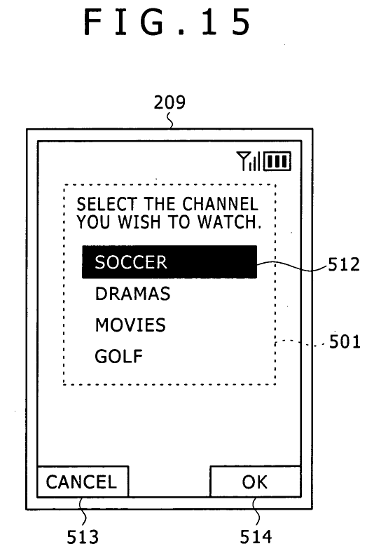

FIG. 15 is a schematic view showing a typical screen appearing on the display unit 209 of the mobile phone 18 as a list of available channels.

In the example of FIG. 15, an explanatory sentence “SELECT THE CHANNEL YOU WISH TO WATCH” appears in an area 511 on the display unit 209 of the mobile phone 18. Under the sentence in the area 501 is a list of available channels “SOCCER,” “DRAMAS,” “MOVIES” and “GOLF”, as shown in FIG. 14, reflecting the subscription channel information held in the mobile directory (MDR) 20 (i.e., SDR information shown in FIG. 13).

The display unit 209 also displays a cancel button 513 and an OK button 514.

In the example of FIG. 15, the list of available channels is displayed on the basis of the operation menu structure described in FIG. 14. This display may be varied depending on the circumstances. That is, while the operation menu structure in FIG. 14 is arranged to provide a list of available channels from both free and subscription broadcasts, at least either free broadcast channels or subscription broadcast channels may be displayed. In the example of FIG. 15, only the available channels of the subscription broadcast are displayed.

Alternatively, the available channels of the free broadcast alone may be displayed. As another alternative, the available channels of both the free and the subscription broadcasts may be displayed simultaneously.

In step S20 back in FIG. 8, when the user 11 operates on the user-specific operation menu displayed on the display unit 209 of the mobile phone 18, the mobile adapter 19 encrypts corresponding data (command) and sends the encrypted data (command) to the TV receiver 53, for example, through infrared data communication links.

For example, suppose that in step S20, the user manipulates a cursor 512 to designate the channel “SOCCER,” one of the chargeable channels to which the user 11 subscribes, on the display unit 209 of the mobile phone 18 and presses the OK button 514. In that case, the mobile adapter 19 encrypts information for specifying the reception of the designated channel (e.g., command “0x0101” in FIG. 14), as well as the subscription ID “xxxxx” and password “yyyyy” for the chargeable broadcast (Casper TV 1) to which the user 11 subscribes, the subscription ID and password being held in the mobile directory (MDR) 20 of the mobile adapter 19. The data thus encrypted is sent from the mobile adapter 19 to the TV receiver 53 (or to a satellite broadcast tuner attached to the TV receiver 53) through infrared data communication links.

In step S51, the TV receiver 53 (or the satellite broadcast tuner attached to the TV receiver 53) receives the encrypted data from the mobile adapter 19, for example, through infrared data communication links. The TV receiver 53 decrypts the received data, carries out necessary operations based on the decrypted data, and terminates the process.

For example, in step S51, the TV receiver 53 receives from the mobile adapter 19 the encrypted information (command) specifying reception of the designated channel as well as the encrypted subscription ID and password for the chargeable broadcast (Casper TV 1) through infrared data communication links. The TV receiver 53 decrypts the received command, subscription ID, and password; starts receiving the user 11 designated channel “SOCCER” of the chargeable broadcast (Casper TV 1) based on the decrypted command (e.g., command “0x0101” in FIG. 14), subscription ID “xxxxx,” and password “yyyyy”; and displays pictures of the received channel “SOCCER” on the screen of the TV receiver 53.

As described, the user 11 carrying around the mobile phone 18 and the mobile adapter 19 connected to the mobile phone 18 can view channels of the chargeable broadcast to which the user 11 subscribes not only on the TV receiver (not shown) at the user 11's own home 12 but also on the TV receiver 53 at the friend's home 21. At the friend's home 21 where there is no environment permitting access to the Internet 14, the mobile phone 19 can connect to the Internet 14 through the mobile phone network 17 and Internet gateway 16. The mobile phone 19 connection allows the user to watch channels of the chargeable broadcast on the TV receiver 53 at the friend's home 21 just as in the user 11's home 12.

In steps S18, S19, S44 and S45 above, preference information about the user 11 (e.g., subscription channels “MOVIES” and “GOLF” of the user 11) was shown to be received as the PDR information from the personal computer 44 in which the personal directory (PDR) 45 is active, the received information being placed into the mobile directory (MDR) 20. Alternatively, these steps may not be carried out at all.

The processes shown executed by the individual devices in the sequence diagram of FIG. 8 are described below in more detail with reference to the flowcharts of FIGS. 16 through 23.

How the mobile adapter 19 acquires PDR information is first described with reference to the flowcharts of FIGS. 16 and 17. The two flowcharts describe further details of steps S11 through S16, S18 and S19 to be carried out by the mobile adapter 19 in the sequence diagram of FIG. 8.

In step S101, the input unit 113 reads the fingerprint of the user 11. The input unit 113 generates fingerprint data based on the collected fingerprint of the user 11, and supplies the generated fingerprint data to the fingerprint data determination block 161.

In step S102, the fingerprint data determination block 161 checks to determine whether the fingerprint data on the user 11 coming from the input unit 113 is valid. For example, the fingerprint data determination block 161 determines the validity of the user 11's fingerprint data supplied from the input unit 113, by comparing the fingerprint data from the input unit 113 with previously stored fingerprint data in the storage unit 104 for coincidence.

If in step S102 the fingerprint data is not found valid, that means someone other than the user 11 (i.e., illicit user) is trying to use the mobile adapter 19. The process is then aborted. That is, no one other than the user 11 can use the mobile adapter 19.

If the user authentication above fails, the mobile adapter 19 is inoperable. This prevents an unscrupulous party from illicitly retrieving from the personal directory (PDR) 45 such personal information as the name and card number of the user 11 or the privacy information such as channel preferences of the user 11.

If in step S102 the fingerprint data is found valid, then step S103 is reached. In step S103, the sender 127 of the communication unit 108 under control of the communication control block 163 establishes communication with nearby devices, for example, through Bluetooth radio link-up and broadcasts an SDR detection request to these devices.

In step S104, the communication control block 163 checks to determine whether any nearby device is responding to the request. If there is a device with its space directory (SDR) active located near the mobile adapter 19, that device responds to the SDR detection request. If there is no such device close to the mobile adapter 19, no response is received.

If no response is detected in step S104, that means there is no device with its space directory (SDR) active in the vicinity of the mobile adapter 19. Control is then returned to step S103 and the detection of a response is repeated. That is, the mobile adapter 19 (in the mobile phone 18) carried by the user 11 broadcasts the SDR detection request periodically by the wireless communication (e.g., over a wireless LAN or through Bluetooth radio link-up).

If a response is detected in step S104, that means there is a device whose space directory (SDR) is active located close to the mobile adapter 19. In that case, step S105 is reached. In step S105, the receiver 126 of the communication unit 108 communicates with the responding device through Bluetooth radio link-up and receives the SDR information from the device provided its space directory (SDR) is active. The receiver 126 of the communication unit 108 supplies the received SDR information to the network determination block 162.

If the user 11 in step S105 is at the user's own home 12, the receiver 126 of the communication unit 108 receives the SDR information shown in FIG. 9 from the space directory (SDR) 43 active in the home appliance 42. If in step S105 the user 11 is at the friend's home 21, the receiver 126 of the communication unit 108 receives the SDR information shown in FIG. 11 from the space directory (SDR) 52 active in the home appliance 51.

In step S106, the network determination block 162 checks to determine whether any device whose personal directory (PDR) is active is on the same home network based on the SDR information supplied from the receiver 126 of the communication unit 108 and on an internally stored device ID of the device whose personal directory (PDR) is active.

In step S106, for example, the network determination block 162 determines whether any device whose personal directory (PDR) 45 is active is located on the same home network, by checking to see if the device ID of the personal computer 44 with its personal directory (PDR) 45 active in the storage unit 104 is included in the SDR information based on the SDR information supplied from the receiver 126 of the communication unit 108 and on the internally stored device ID of the device whose personal directory (PDR) is active.

If in step S106 any device whose personal directory (PDR) 45 is active is found on the same home network, then step S107 is reached. In step S107, the sender 127 of the communication unit 108 communicates with the device with its personal directory (PDR) active through Bluetooth radio link-up under control of the communication control block 163, and sends a PDR acquisition request to that device on the home network.

In step S107, for example, with the user at the home 12, the sender 127 of the communication unit 108 communicates with the personal computer 44 through Bluetooth radio link-up under control of the communication control block 163 and sends the PDR acquisition request to the PC 44 in which the personal directory (PDR) 45 is active on the home network.

In step S108, the receiver 126 of the communication unit 108 communicates with any device whose personal directory (PDR) 45 is active through Bluetooth radio link-up under control of the communication control block 163 and receives PDR information subsets from that device. The received PDR information subsets are forward to the CPU 101 from the receiver 126 of the communication unit 108.

In step S108, for example, the receiver 126 of the communication unit 108 communicates with the personal computer 44 through Bluetooth radio link-up under control of the communication control block 163 and receives subsets of the PDR information shown in FIG. 13 from the PC 44 provided its personal directory (PDR) 45 is active on the home network. The received PDR information in FIG. 3 is sent to the CPU 101.

If in step S106 there does not exist any device whose personal directory (PDR) is active on the same home network, then step S109 is reached. In step S109, the network determination block 162 checks to determine whether there is an access point on the home network based on the SDR information supplied from the receiver 126 of the communication unit 108. That is, the network determination block 162 determines whether there is an access point on the home network according to information specifying connectivity—or its absence—to the Internet 14 as part of the SDR information sent from the receiver 126 of the communication unit 108.

If in step S109 an access point is found on the home network, then step S110 is reached. In step S110, the sender 127 of the communication unit 108 accesses the Internet 14 through the access point under control of the communication control block 163, and sends a PDR acquisition request to the device in which the personal directory (PDR) 45 is active.

In step S110, for example, with the user 11 at the friend's home 21, the sender 127 of the communication unit 108 communicates with the home appliance 51 through Bluetooth radio link-up under control of the communication control block 163, and sends a PDR acquisition request to the access point (not shown) in the friend's home 21 through the home appliance 51. Given the PDR acquisition request, the access point forwards it to the personal computer 44 whose personal directory (PDR) 45 is active in the user's home 12 through the Internet 14, provider A 13, and router 41.

Address information necessary for connecting to the personal computer 44 may be stored beforehand in conjunction with the device ID as part of the SDR information for subsequent acquisition. Alternatively, the address information corresponding to the device ID of the personal computer 44 may be acquired by way of the ancestor directory server 15 connected to the Internet 14.

In step S111, the receiver 126 of the communication 108 under control of the communication control block 163 receives subsets of PDR information from the device in which the personal directory (PDR) 45 is active through the access point (not shown) on the home network. The received PDR information subsets are sent to the CPU 101 from the receiver 126 of the communication unit 108.

In step S111, for example, the home appliance 51 receives subsets of the PDR information shown in FIG. 13 from the personal computer 44 whose personal directory (PDR) 45 is active at the user's home 12 through the router 41, provider A 13, the Internet 14, and access point (not shown) on the home network. Under control of the communication control block 163, the receiver 126 of the communication unit 108 communicates with the home appliance 51 through Bluetooth radio link-up, receives subsets of the PDR information shown in FIG. 13, and forwards the received PDR information to the CPU 101.

If in step S109 no access point is found on the home network, then step S112 is reached. In step S112, the output unit 132 of the communication unit 109 outputs a PDR acquisition request to the input unit 226 of the communication unit 208 in the mobile phone 18 under control of the communication control block 163.

When the SDR information received from the home appliance 51 is not found to include any device ID matching an internally stored device ID of the personal computer 44 in which the personal directory (PDR) 45 is active, the mobile adapter 19 recognizes that the personal computer 44 with its personal directory (PDR) 45 active does not exist on the local network of the friend's home 21. The mobile adapter 19 also finds out that the home appliance 51 cannot access the Internet 14 according to information specifying connectivity—or its absence—to the Internet 14 as part of the SDR information received from the home appliance 51. In that case, the mobile adapter 19 causes the mobile phone 18 to access the Internet 14 and to send a PDR acquisition request to the personal computer 44 whose personal directory (PDR) 45 is active through the mobile phone network 17, Internet gateway 16, the Internet 14, provider A 13, and router 41.

Address information necessary for connecting to the personal computer 44 may be stored beforehand in conjunction with the device ID as part of the SDR information for subsequent acquisition. Alternatively, the address information corresponding to the device ID of the personal computer 44 may be acquired by way of the ancestor directory server 15 connected to the Internet 14.

In step S113, the input unit 131 of the communication unit 109 under control of the communication control block 163 inputs subsets of the PDR information from the output unit 227 of the communication unit 208 in the mobile phone 18. The input PDR information subsets are supplied to the CPU 101 from the output unit 227 of the communication unit 208 in the mobile phone 18.

In step S113, for example, the input unit 131 of the communication unit 109 under control of the communication control block 163 inputs subsets of the PDR information shown in FIG. 13 from the output unit 227 of the communication unit 208 in the mobile phone 18. The input PDR information in FIG. 13 is forwarded to the CPU 101.

More specifically, the output unit 132 of the communication unit 109 in step S112 causes the mobile phone 18 to access the Internet 14 and to send a PDR acquisition request to the personal computer 44 in which the personal directory (PDR) 45 is active through the mobile phone network 17, Internet gateway 16, the Internet 14, provider A 13, and router 41. In turn, the input unit 131 of the communication unit 109 in step S113 inputs the PDR information subsets received by the mobile phone 18 from the personal computer 44 through the router 41, provider A 13, the Internet 14, Internet gateway 16, mobile phone network 17, and mobile phone 18.

As described, if the home appliance 51 is not connected to an access point of the Internet 14, the mobile phone network 17 is arranged to access the Internet 14 through the mobile phone network 17 and Internet gateway 16. The arrangement allows the PDR information to be acquired from the personal computer 44 in which the personal directory (PDR) 45 is active.

In step S114, the CPU 101 receives the PDR information subsets from the receiver or input unit 131 of the communication unit 109 and stores the received PDR information subsets into the mobile directory (MDR) 20 in the storage unit 104. In step S114, for example, the CPU 101 receives the PDR information described in FIG. 13 from the receiver or input unit 131 of the communication unit 109 and places the received PDR information into the mobile directory (MDR) 20 in the storage unit 104.

As described, the mobile directory (MDR) 20 of the mobile adapter 19 retains subsets of the PDR information that is kept in the personal directory (PDR) 45. When the appropriate information included in the PDR information subsets is sent to the home appliance 51 (or home appliance 42), it is possible to display a menu customized to the user 1's taste on the display unit 209 of the mobile phone 18 or to make the home appliance 51 (or 42) carry out processes specific to the user 11.

In step S115, the control data generation block 164 generates data for displaying a list of communicable devices based on the SDR information received in step S105. The control data generation block 164 then supplies the display control block 165 with the generated data for displaying the communicable device list.

In step S115, for example, the control data generation block 164 generates data for generating a list of communicable devices based on the device type data and other suitable data items in the SDR information which is shown in FIG. 11 and which was received in step S105. The generated data for displaying the communicable device list is then supplied to the display control block 165.

In step S116, the display control block 165 displays on the screen the communicable device list based on the data generated and supplied by the control data generation block 164 for displaying that list.

In step S116, for example, the display control block 165 causes the display unit 209 of the mobile phone 18 to display the name of the TV receiver 53 (e.g., the device name shown in FIG. 12) as a device capable of communicating with the mobile adapter 19, on the basis of the data generated and supplied by the control data generation block 164 for displaying the communicable device list.

In step S117, the control data generation block 164 responds to the user's operations on the list of communicable devices displayed on the screen, by generating operation menu data (i.e., control data) specific to the user based on the SDR information and on the information held in the mobile directory (MDR) 20. The control data generation block 164 then supplies the display control block 165 with the user-specific operation menu data (control data) thus generated.

In step S117, for example, the user performs operations to select the name of the TV receiver 53 displayed as the device communicable with the mobile phone 18 and presses the OK button 503. In response, the control data generation block 164 generates user-specific operation menu data (e.g., operation menu structure shown in FIG. 14) based on the SDR information (shown in FIG. 11) and on the information held in the mobile directory (MDR) 20 (e.g., PDR information shown in FIG. 13). The user-specific operation menu data thus generated is supplied to the display control block 165.

That is, the control data generation unit 164 generates an operation menu of available channels as an operation menu specific to the user 11 based on the information about the TV receiver 53 received from the space directory (SDR) 52 of the home appliance 51 and on the information about the subscription channels of the chargeable broadcast to which the user 11 subscribes.

In step S118, the display control block 165 displays on the screen the user-specific operation menu data supplied from the control data generation block 164.

In step S118, for example, the display control block 165 causes the display unit 209 of the mobile phone 18 to display a list of channels available to the user 11 as a user-specific operation menu based on the operation menu structure which was supplied from the control data generation unit 164 and which is shown, for example, in FIG. 14.

In step S119, in response to the user's operations, the sender 127 of the communication unit 108 establishes communication with the selected communicable device, for example, through Bluetooth radio link-up and sends appropriate data to the selected device.

In step S119, for example, the user may perform operations on the display unit 209 of the mobile phone 18 so as to designate by the cursor 512 the subscription channel “SOCCER” of the chargeable broadcast to which the user 11 subscribes, before pressing the OK button 514. In that case, the mobile adapter 19 encrypts information for specifying the reception of the designated channel (e.g., command “0x0101” in FIG. 14), as well as the subscription ID “xxxxx” and password “yyyyy” for the chargeable broadcast (Casper TV 1) under contract with the user 11, the subscription ID and password being held in the mobile directory (MDR) 20 of the mobile adapter 19. The data thus encrypted is sent from the mobile adapter 19 to the TV receiver 53 (or to the satellite broadcast tuner attached to the TV receiver 53) through infrared data communication links.

The TV receiver 53 thus receives from the mobile adapter 19 the encrypted information (command) specifying reception of the designated channel as well as the encrypted subscription ID and password for the chargeable broadcast (Casper TV 1) through infrared data communication links. The TV receiver 53 decrypts the received command, subscription ID, and password; starts receiving the user-designated channel “SOCCER” of the chargeable broadcast (Casper TV 1) based on the decrypted command (e.g., command “0x0101” in FIG. 14), subscription ID “xxxxx,” and password “yyyyy”; and displays pictures of the received channel “SOCCER” on the screen.

As described, the user 11 carrying around the mobile phone 18 and the mobile adapter 19 connected to it can view channels of the chargeable broadcast to which the user 11 subscribes not only on the TV receiver (not shown) at the user's own home 12 but also on the TV receiver 53 at the friend's home 21. At the friend's home 21 where there is no environment permitting access to the Internet 14, the mobile phone 19 is arranged to connect to the Internet 14 through the mobile phone network 17 and Internet gateway 16. The mobile phone connection allows the user to watch channels of the chargeable broadcast on the TV receiver at the friend's home 21 just as in the user's home 12.

It is not mandatory to adopt the Bluetooth radio link technology shown accepted as the primary communication standard in the foregoing description with regard to the flowcharts of FIGS. 16 and 17. Alternatively, the communication unit 107 under control of the communication control block 163 may communicate with other devices over a wireless LAN for data sending and reception.

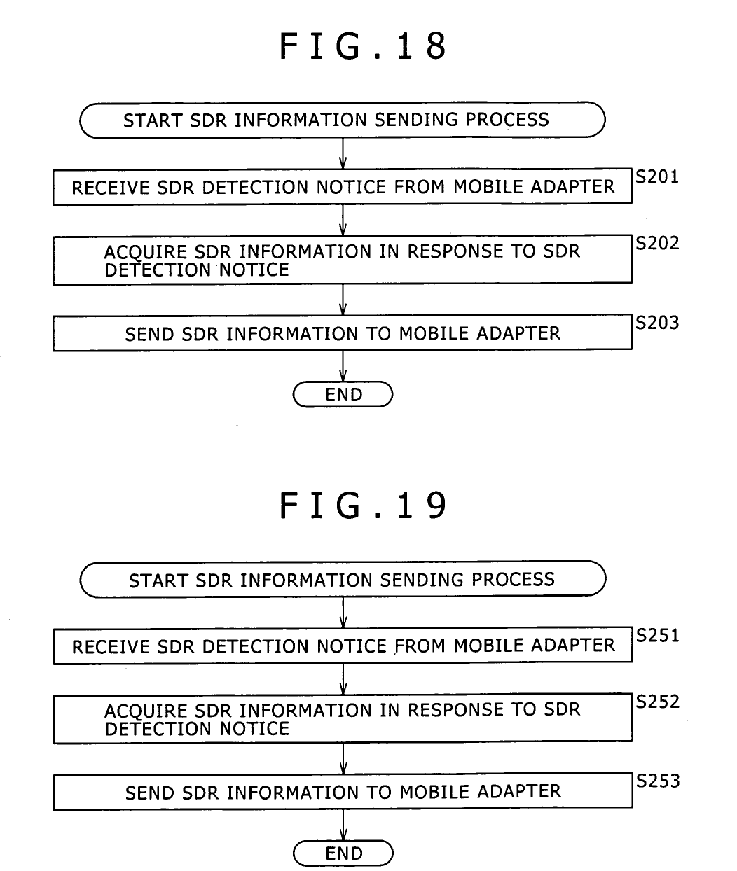

Described below with reference to the flowchart of FIG. 18 is an SDR information sending process performed by the home appliance 42 at the user's home 12. This process constitutes details of steps S31 and S32 to be carried out by the home appliance 42 in the sequence diagram of FIG. 8.

In step S201, the receiver 311 of the wireless communication unit 301 establishes communication with the mobile adapter 19 through Bluetooth radio link-up and receives an SDR detection notice from the mobile adapter 19. The received SDR detection notice is forwarded from the receiver 311 to the system control unit 303.

In step S202, the system control unit 303 acquires the SDR information from the space directory (SDR) 43 in the storage unit 304 in response to the SDR detection notice coming from the receiver 311 of the wireless communication unit 301. The SDR information thus acquired is forwarded from the system control unit 303 to the sender 312 of the wireless communication unit 301.

In step S202, for example, the system control unit 303 receives the SDR detection notice from the sender 311 of the wireless communication unit 301 and acquires accordingly from the space directory (SDR) 43 the SDR information constituted by the device information about the device or devices in the local area of the user's home 12 (e.g., SDR information shown in FIG. 9) and by the setting information for accessing the Internet 14. The device information and setting information thus acquired are sent from the system control unit 303 to the sender 312 of the wireless communication unit 301.

In step S203, the sender 312 of the wireless communication unit 301 establishes communication with the mobile adapter 19 through Bluetooth radio link-up and sends the SDR information that came from the system control unit 303 to the mobile adapter 19. This completes the process of FIG. 18.

In step S203, for example, the sender 312 of the wireless communication unit 301 communicates with the mobile adapter 19 in a Bluetooth radio link-up and sends to the mobile adapter 19 the device information about the device or devices in the local area of the user's home 12 (e.g., SDR information in FIG. 9) and the setting information for connecting to the Internet 14. The two kinds of information have been supplied from the system control unit 303.

The communication standard according to which the wireless communication unit 301 sends and receives data is not limited to the Bluetooth radio link technology. Alternatively, the wireless communication unit 301 may communicate with the mobile adapter 19 over a wireless LAN for data sending and reception. The wireless communication unit 301 may adopt any suitable communication standard that may be used by the party to and from which data is sent and received.

Described below with reference to the flowchart of FIG. 19 is an SDR information sending process performed by the home appliance 51 at the friend's home 21. This process constitutes details of steps S61 and S62 to be carried out by the home appliance 51 in the sequence diagram of FIG. 8.

In step S251, the receiver 361 of the wireless communication unit 351 establishes communication with the mobile adapter 19 through Bluetooth radio link-up and receives an SDR detection notice from the mobile adapter 19. The received SDR detection notice is forwarded from the receiver 361 to the system control unit 354.

In step S252, the system control unit 354 acquires the SDR information from the space directory (SDR) 52 in the storage unit 355 in response to the SDR detection notice coming from the receiver 361 of the wireless communication unit 351. The SDR information thus acquired is forwarded from the system control unit 354 to the sender 362 of the wireless communication unit 351.

In step S252, for example, the system control unit 354 receives the SDR detection notice from the sender 361 of the wireless communication unit 351 and acquires accordingly from the space directory (SDR) 52 the SDR information constituted by the device information about the device or devices in the local area of the friend's home 21 (e.g., SDR information shown in FIG. 11) and by information specifying whether the device or devices are connectable to the Internet 14 (e.g., information indicating that the home appliance 51 is not capable of accessing the Internet 14). The device information and connectivity information thus acquired are sent from the system control unit 354 to the sender 362 of the wireless communication unit 351.

In step S253, the sender 362 of the wireless communication unit 351 establishes communication with the mobile adapter 19 through Bluetooth radio link-up and sends the SDR information that came from the system control unit 354 to the mobile adapter 19. This completes the process of FIG. 19.

In step S253, for example, the sender 362 of the wireless communication unit 351 communicates with the mobile adapter 19 in a Bluetooth radio link-up and sends to the mobile adapter 19 the device information about the device or devices in the local area of the friend's home 21 (e.g., SDR information in FIG. 11) and the information for specifying whether the device or devices are connectable to the Internet 14 (e.g., information indicating that the home appliance 51 is not connectable to the Internet 14). The two kinds of information have been supplied from the system control unit 354.

The communication standard according to which the wireless communication unit 351 sends and receives data is not limited to the Bluetooth radio link technology. Alternatively, the wireless communication unit 351 may communicate with the mobile adapter 19 over a wireless LAN for data sending and reception. The wireless communication unit 351 may adopt any suitable communication standard that may be used by the party to and from which data is sent and received.

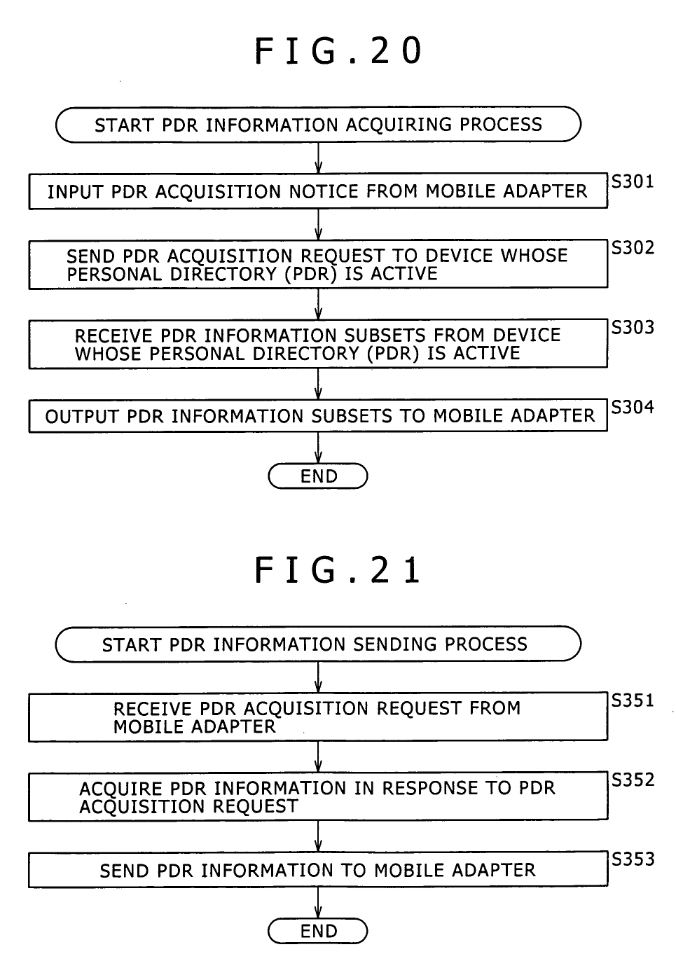

Described below with reference to the flowchart of FIG. 20 is a PDR information acquiring process performed by the mobile phone 18 connected to the mobile adapter 19. This process constitutes those details of steps S17, S43, S18, S44, S19, and S45 which are to be carried out by the mobile phone 18 in the sequence diagram of FIG. 8.

In step S301, the input unit 226 of the communication unit 208 inputs a PDR acquisition request from the output unit 132 of the communication unit 109 in the mobile adapter 19. Under control of the CPU 201 responding to the PDR acquisition request (or to a suitable command), the input unit 226 of the communication unit 208 forwards to the sender 222 of the communication unit 207 the PDR acquisition request that has been input from the output unit 132 of the communication unit 109 in the mobile adapter 19.

For example, if the user 11 is at the friend's home 21 in step S112, the absence of an access point on the home network of the friend's home 21 prompts the output unit 132 of the communication unit 109 in the mobile adapter 19 to output a PDR acquisition request to the input unit 226 of the communication unit 208 under control of the communication control block 163. As a result, the input unit 226 of the communication unit 208 inputs the PDR acquisition request from the output unit 132 of the communication unit 109 in the mobile adapter 19.

In step S302, the sender 222 of the communication unit 207 sends the PDR acquisition request coming from the input unit 226 of the communication unit 208 to the device in which the personal directory (PDR) is active through the Internet 14.

In step S302, for example, the sender 222 of the communication unit 207 sends the PDR acquisition request input from the input unit 226 of the communication unit 208 to the personal computer 44 through the mobile phone network 17, Internet gateway 16, the Internet 14, provider A 13, and router 41.

For example, with the user 11 at the friend's home 21, the home appliance 51 in which the space directory (SDR) 52 is active is not capable of accessing the Internet 14 (because of the absence of an Internet access point). Instead, the mobile adapter 19 connects the mobile phone 18 to the Internet 14 through the mobile phone network 17 and Internet gateway 16. The mobile phone 18 connected to the Internet 14 sends the PDR acquisition request to the personal computer 44 through the mobile phone network 17, Internet gateway 16, the Internet 14, provider A 13, and router 41.

The mobile phone 18 is arranged to access the Internet 14 through the mobile phone network 17 and Internet gateway 16 on the basis of the PDR acquisition request (or suitable command) input from the mobile adapter 19.

In step S303, the receiver 221 of the communication unit 207 receives subsets of the PDR information from the device whose personal directory (PDR) is active through the Internet 14. The received PDR information subsets are supplied from the receiver 221 to the output unit 227 of the communication unit 208. In step S303, for example, the receiver 221 of the communication unit 207 receives subsets of the PDR information from the personal computer 44 through the router 41, provider A 13, the Internet 14, Internet gateway 16, and mobile phone network 17. The received PDR information subsets are sent from the receiver 221 to the output unit 227 of the communication unit 208.

In step S304, the output unit 227 of the communication unit 208 outputs the PDR information coming from the receiver 221 of the communication unit 207 to the input unit 131 of the communication unit 109 in the mobile adapter 19. This completes the process of FIG. 20.

As described, the mobile phone 18 receives the PDR acquisition request (or suitable command) from the mobile adapter 19 and, if no access point to the Internet 14 is found in the vicinity, connects accordingly to the Internet 14 through the mobile phone network 17 to receive the PDR information from the device in which the personal directory (PDR) is active. The received PDR information is output from the mobile phone 18 to the mobile adapter 19.

Described below with reference to the flowchart of FIG. 21 is a PDR information sending process performed by the personal computer 44 in which the personal directory (PDR) 45 is active. The flowchart of FIG. 21 constitutes details of steps S41, S42, S44 and S45 to be carried out by the personal computer 44 in the sequence diagram of FIG. 8.

In step S351, the receiver 431 of the communication unit 409 establishes connection with the mobile adapter 19, for example, through Bluetooth radio link-up and receives a PDR acquisition request from the mobile adapter 19. The received PDR acquisition request is supplied from the receiver 431 to the CPU 401.

In step S352, in response to the PDR acquisition request from the receiver 431 of the communication unit 409, the CPU 401 acquires subsets of the PDR information from the personal directory (PDR) 45 in the storage unit 408. The CPU 401 forwards the acquired PDR information subsets to the sender 432 of the communication unit 409.

In step S352, for example, the CPU 401 acquires the PDR information (shown in FIG. 13) from the personal directory (PDR) 45 in the storage unit 408 in response to the PDR acquisition request received from the mobile adapter 19. The PDR information thus acquired is forwarded to the sender 432 of the communication unit 409.

In step S353, the sender 432 of the communication unit 409 establishes communication with the mobile adapter 19, for example, through Bluetooth radio link-up and sends to the mobile adapter 19 subsets of the PDR information supplied from the CPU 401. This completes the process of FIG. 21.

In step S353, for example, the sender 432 of the communication unit 409 communicates with the mobile adapter in a Bluetooth radio link-up and sends to the mobile adapter 19 the PDR information which was forwarded from the CPU 401 and which is shown in FIG. 13.

The communication standard according to which the communication unit 409 sends and receives data is not limited to the Bluetooth radio link technology. Alternatively, the communication unit 409 may communicate with the mobile adapter 19 over a wireless LAN for data sending and reception. The communication unit 409 may adopt any suitable communication standard that may be used by the party to and from which data is sent and received.

If in step S351 the receiver 436 of the communication unit 410 receives the PDR acquisition request from the mobile phone 18 through the router 41, provider A 13, the Internet 14, Internet gateway 16, and mobile phone network 17, the storage unit 408 allows subsets of the PDR information to be supplied likewise from the personal directory (PDR) 45 to the sender 437 of the communication unit 410. In turn, the sender 437 sends the PDR information subsets to the mobile phone 18 through the router 41, provider A 13, the Internet 14, Internet gateway 16, and mobile phone network 17.

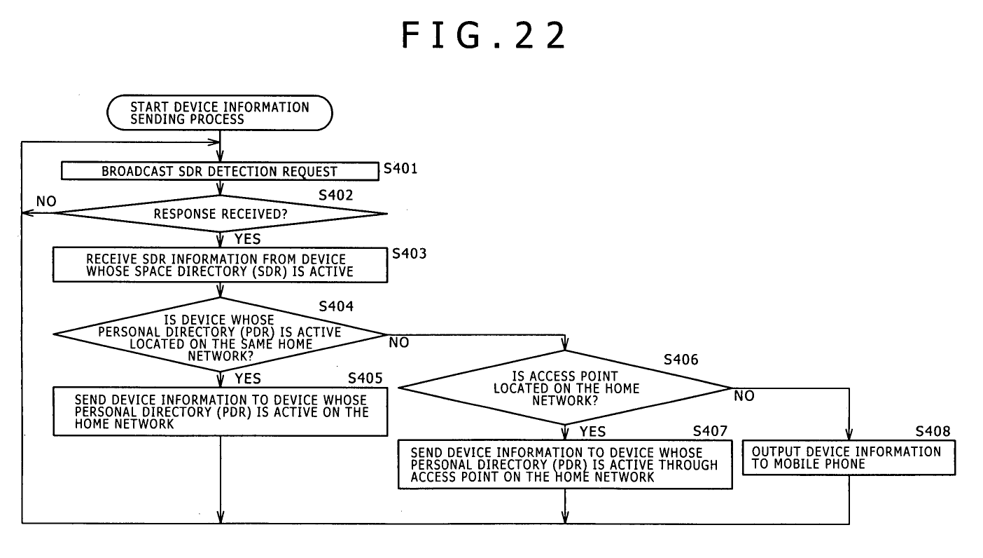

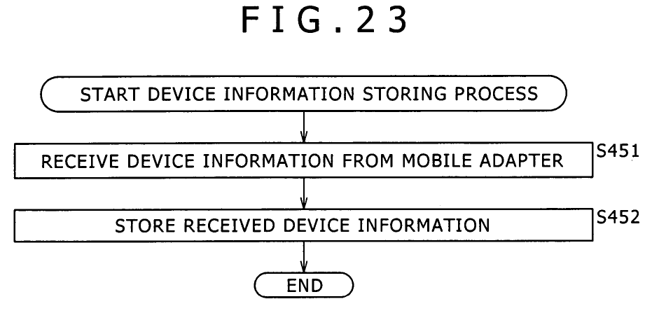

Described below with reference to the flowcharts of FIGS. 22 and 23 are processes for storing into the personal directory (PDR) 45 the device information about the device or devices in the vicinity of the mobile adapter 19. The personal directory (PDR) 45 is arranged to retain at all times the device information about any device that may be located near the mobile adapter 19.

How the device information is sent by the mobile adapter 19 will now be described with reference to the flowchart of FIG. 22. This is a flowchart that explains details of step S17 to be carried out by the mobile adapter 19 in the sequence diagram of FIG. 8.

Steps S401 through S404 in FIG. 22 are the same as steps S103 through S106 in FIG. 16 and thus will not be discussed further.

In step S405, the sender 127 of the communication unit 108 under control of the communication control block 163 establishes Bluetooth radio link communication with the device whose personal directory (PDR) is active on the home network, and sends the device information out of the SDR information to that device with its personal directory (PDR) active. From step S405, control is returned to step S401 and the subsequent steps are repeated.

In step S405, for example, with the user 11 at the user's own home 12, the sender 127 of the communication unit 108 communicates with the personal computer 44 through Bluetooth radio link-up under control of the communication control block 163 and sends the device information out of the SDR information to the personal computer 44 with its personal directory (PDR) 45 active on the home network.

Step S406 in FIG. 22 is the same as step S109 in FIG. 16 and thus will not be discussed further.

In step S407, the sender 127 of the communication unit 108 under control of the communication control block 163 accesses the Internet 14 through an access point (not shown) on the home network, and sends the device information out of the SDR information to the device in which the personal directory (PDR) is active. After step S407, control is returned to step S401 and the subsequent steps are repeated.

In step S407, for example, with the user 11 at the friend's home 21, the sender 127 of the communication unit 108 communicates with the home appliance 51 through Bluetooth radio link-up under control of the communication control block 163, and sends the device information out of the SDR information to the access point (not shown) at the friend's home 21 via the home appliance 51. Given the PDR acquisition request, the access point forwards the request to the personal computer 44 whose personal directory (PDR) 45 is active at the user's home 12 through the Internet 14, provider A 13, and router 41.

In step S408, the output unit 132 of the communication unit 109 under control of the communication control block 163 outputs the device information out of the SDR information to the input unit 226 of the communication unit 208 in the mobile phone 18. From step S408, control is returned to step S401 and the subsequent steps are repeated.

When the SDR information received from the home appliance 51 is not found to include any device ID matching an internally stored device ID of the personal computer 44 in which the personal directory (PDR) 45 is active, the mobile adapter 19 recognizes that the personal computer 44 with its personal directory (PDR) 45 active does not exist on the local network of the friend's home 21. The mobile adapter 19 also finds out that the home appliance 51 cannot access the Internet 14 according to information specifying connectivity—or its absence—to the Internet 14 as part of the SDR information. In that case, the mobile adapter 19 causes the mobile phone 18 to access the Internet 14 and to send the device information out of the SDR information to the personal computer 44 whose personal directory (PDR) 45 is active through the mobile phone network 17, Internet gateway 16, the Internet 14, provider A 13, and router 41.

Address information necessary for connecting to the personal computer 44 may be stored beforehand in conjunction with the device ID as part of the SDR information for subsequent acquisition. Alternatively, the address information corresponding to the device ID of the personal computer 44 may be acquired by way of the ancestor directory server 15 connected to the Internet 14.

The process of acquiring PDR information outlined in the flowcharts of FIGS. 16 and 17 was described separately from the process of sending device information in the flowchart of FIG. 22 for purpose of simplification and illustration. Alternatively, the two processes may be executed as part of the series of steps depicted above with reference to the sequence diagram in FIG. 8.

With regard to the process in the flowchart of FIG. 22, the communication standard to be adopted is not limited to the Bluetooth radio link technology. Alternatively, under control of the communication control block 163, the sender 122 of the communication unit 107 may communicate with other devices over a wireless LAN for data sending and reception.

Described below with reference to the flowchart of FIG. 23 is a device information storing process performed by the personal computer 44. This process constitutes details of steps S43 to be carried out by the personal computer 44 in the sequence diagram of FIG. 8.

In step S451, the receiver 431 of the communication unit 409 establishes communication with the mobile adapter 19, for example, through Bluetooth radio link-up and receives device information from the mobile adapter 19. The received device information is forwarded from the receiver 431 to the CPU 401.

In step S451, for example, the receiver 431 of the communication unit 409 communicates with the mobile adapter 19 in a Bluetooth radio link-up and receives the device information about the home appliance 42 from the mobile adapter 19. The received device information about the home appliance 42 is sent from the receiver 431 to the CPU 401.

In step S452, the CPU 401 stores the device information sent from the receiver 431 of the communication unit 409, into the personal directory (PDR) 45 in the storage unit 408 together with a timestamp. This completes the process of FIG. 23.

In step S452, for example, the CPU 401 stores the device information about the home appliance 42 coming from the receiver 431 of the communication unit 409, into the personal directory (PDR) 45 in the storage unit 408 along with a timestamp.

As described, the mobile adapter 19 connected to the mobile phone 18 carried around by the user 11 broadcasts the SDR detection request periodically in wireless fashion (e.g., over a wireless LAN or through Bluetooth radio link-up), acquires in turn the device information from the device in which the space directory (SDR) is active, and sends the acquired device information to the device whose personal directory (PDR) is active. The device with its personal directory (PDR) active causes the received device information to be stored into that personal directory together with a timestamp. In this manner, the personal directory (PDR) is arranged to hold the device information about the device or devices capable of communicating with the mobile adapter 19.

The communication standard according to which the communication unit 409 sends and receives data is not limited to the Bluetooth radio link technology. Alternatively, the communication unit 409 may communicate with the mobile adapter 19 over a wireless LAN for data sending and reception. The communication unit 409 may adopt any suitable communication standard that may be used by the party to and from which data is sent and received.

If in step S451 the receiver 436 of the communication unit 410 receives the device information from the mobile phone 18 through the router 41, provider A 13, the Internet 14, Internet gateway 16, and mobile phone network 17, the device information about the home appliance 51 is likewise stored from the receiver 436 into the personal directory (PDR) 45 in the storage unit 408 along with a timestamp.

As described, even if there is no access point to the Internet 14 in the vicinity, the mobile adapter 19 can cause the mobile phone to access the Internet 14. The mobile phone connection allows the mobile adapter to send and receive diverse kinds of information via the Internet 14.

The series of steps or processes described above may be executed either by hardware or by software. For the software-based processing to take place, the programs constituting the software may be either incorporated beforehand in dedicated hardware of a computer or installed upon use from a suitable recording medium into a general-purpose personal computer or like equipment capable of executing diverse functions based on the installed programs.

As shown in FIG. 7, the recording medium is provided to the user not only as a package medium apart from the computer and constituted by the magnetic disk 421 (including flexible disks), optical disk 422 (including CD-ROM (Compact Disc-Read Only Memory), magneto-optical disk 423 (including MD (Mini-disc; trademark)), or semiconductor memory 424, any of them carrying the necessary programs; but also in the form of a ROM (not shown) accommodating the programs and incorporated beforehand in the computer.

The programs for carrying out the above-described series of steps or processes may be installed into the computer through diverse communication interfaces such as routers and modems, or via wired or wireless communication media including local area networks, the Internet, or digital satellite broadcasting networks.

In this specification, the steps which are stored on the recording medium and which describe the programs to be executed represent not only the processes that are to be carried out in the depicted sequence (i.e., on a time series basis) but also processes that may be performed parallelly or individually and not chronologically.

In this specification, the term “system” refers to an entire configuration made up of a plurality of component devices.

As many apparently different embodiments of this invention may be made without departing from the spirit and scope thereof, it is to be understood that the invention is not limited to the specific embodiments thereof except as defined in the appended claims.

What is claimed is:

1. A communication system comprising an electronic device, a first information providing apparatus providing first information related to a device, and a second information providing apparatus providing second information related to a user;
wherein said electronic device includes:
first sending means for sending to said first information providing apparatus a first request asking sending of said first information;
first receiving means for receiving said first information sent from said first information providing apparatus;
determining means for determining whether said first information providing apparatus is connected to a network based on said first information received by said first receiving means;
storing means for storing connection information for connecting to said second information providing apparatus;
sending controlling means which, if said determining means determines that said first information providing apparatus is not connected to said network, then controls sending to said second information providing apparatus of a second request asking sending of said second information based on said connection information;
reception controlling means for controlling reception of said second information sent from said second information providing apparatus;
generating means for generating control data for controlling said device designated by said first information, in accordance with said first and said second information; and
device controlling means for controlling said device based on operations performed by said user and on said control data;
wherein said first information providing apparatus includes:
second receiving means for receiving said first request sent from said electronic device;
first information storing means for storing said first information; and
second sending means for sending said first information from said first information storing means to said electronic device in accordance with said first request received by said second receiving means; and
wherein said second information providing apparatus includes:
third receiving means for receiving said second request of which the sending is controlled by said electronic device;
second information storing means for storing said second information; and
third sending means for sending said second information from said second information storing means to said electronic device in accordance with said second request received by said third receiving means.

2. An electronic device comprising:
sending means for sending a first request asking sending of first information related to a device, to a first information providing apparatus providing said first information;
receiving means for receiving said first information sent from said first information providing apparatus;
determining means for determining whether said first information providing apparatus is connected to a network based on said first information received by said receiving means;
storing means for storing connection information for connecting to a second information providing apparatus providing second information related to a user;
sending controlling means which, if said determining means determines that said first information providing apparatus is not connected to said network, then controls sending to said second information providing apparatus of a second request asking sending of said second information related to said user in accordance with said connection information;
reception controlling means for controlling reception of said second information sent from said second information providing apparatus;
generating means for generating control data for controlling said device designated by said first information in accordance with said first and said second information; and
device controlling means for controlling said device based on operations performed by said user and on said control data.

3. The electronic device according to claim 2, further comprising display controlling means for controlling display of information specific to said user about said device in accordance with said control data.

4. The electronic device according to claim 2, wherein said sending controlling means causes a communication apparatus to which said electronic device is attached, to send said second request; and
wherein said reception controlling means causes said communication apparatus to receive said second information.

5. An information processing method comprising the steps of:
sending a first request asking sending of first information related to a device, to a first information providing apparatus providing said first information;
receiving said first information sent from said first information providing apparatus;
determining whether said first information providing apparatus is connected to a network based on said first information received in said receiving step;
storing connection information for connecting to a second information providing apparatus providing second information related to a user;
controlling sending to said second information providing apparatus of a second request asking sending of said second information related to said user in accordance with said connection information, if said determining step determines that said first information providing apparatus is not connected to said network;
controlling reception of said second information sent from said second information providing apparatus;
generating control data for controlling said device designated by said first information in accordance with said first and said second information; and
controlling said device based on operations performed by said user and on said control data.

6. A recording medium which stores a program in a manner readable by a computer, said program comprising the steps of:
sending a first request asking sending of first information related to a device, to a first information providing apparatus providing said first information;
receiving said first information sent from said first information providing apparatus;
determining whether said first information providing apparatus is connected to a network based on said first information received in said receiving step;
storing connection information for connecting to a second information providing apparatus providing second information related to a user;
controlling sending to said second information providing apparatus of a second request asking sending of said second information related to said user in accordance with said connection information, if said determining step determines that said first information providing apparatus is not connected to said network;
controlling reception of said second information sent from said second information providing apparatus;
generating control data for controlling said device designated by said first information in accordance with said first and said second information; and
controlling said device based on operations performed by said user and on said control data.

7. A program comprising the steps of:
sending a first request asking sending of first information related to a device, to a first information providing apparatus providing said first information;
receiving said first information sent from said first information providing apparatus;
determining whether said first information providing apparatus is connected to a network based on said first information received in said receiving step;
storing connection information for connecting to a second information providing apparatus providing second information related to a user;
controlling sending to said second information providing apparatus of a second request asking sending of said second information related to said user in accordance with said connection information, if said determining step determines that said first information providing apparatus is not connected to said network;
controlling reception of said second information sent from said second information providing apparatus;
generating control data for controlling said device designated by said first information in accordance with said first and said second information; and
controlling said device based on operations performed by said user and on said control data.

8. A communication system comprising an electronic device, a first information providing apparatus providing first information related to a device, and a second information providing apparatus providing second information related to a user;
wherein said electronic device includes:
a first sending mechanism sending to said first information providing apparatus a first request asking sending of said first information;
a first receiving mechanism receiving said first information sent from said first information providing apparatus;
a determining mechanism determining whether said first information providing apparatus is connected to a network based on said first information received by said first receiving mechanism;
a storing mechanism storing connection information for connecting to said second information providing apparatus;
a sending controlling mechanism which, if said determining mechanism determines that said first information providing apparatus is not connected to said network, then controls sending to said second information providing apparatus of a second request asking sending of said second information based on said connection information;
a reception controlling mechanism controlling reception of said second information sent from said second information providing apparatus;
a generating mechanism generating control data for controlling said device designated by said first information, in accordance with said first and said second information; and
a device controlling mechanism controlling said device based on operations performed by said user and on said control data;
wherein said first information providing apparatus includes:
a second receiving mechanism receiving said first request sent from said electronic device;
a first information storing mechanism storing said first information; and
a second sending mechanism sending said first information from said first information storing mechanism to said electronic device in accordance with said first request received by said second receiving mechanism; and
wherein said second information providing apparatus includes:
a third receiving mechanism receiving said second request of which the sending is controlled by said electronic device;
a second information storing mechanism storing said second information; and
a third sending mechanism sending said second information from said second information storing mechanism to said electronic device in accordance with said second request received by said third receiving mechanism.

9. An electronic device comprising:
a sending mechanism sending a first request asking sending of first information related to a device, to a first information providing apparatus providing said first information;
a receiving mechanism receiving said first information sent from said first information providing apparatus;
a determining mechanism determining whether said first information providing apparatus is connected to a network based on said first information received by said receiving mechanism;
a storing mechanism storing connection information for connecting to a second information providing apparatus providing second information related to a user;
a sending controlling mechanism which, if said determining mechanism determines that said first information providing apparatus is not connected to said network, then controls sending to said second information providing apparatus of a second request asking sending of said second information related to said user in accordance with said connection information;
a reception controlling mechanism controlling reception of said second information sent from said second information providing apparatus;
a generating mechanism generating control data for controlling said device designated by said first information in accordance with said first and said second information; and
a device controlling mechanism controlling said device based on operations performed by said user and on said control data.
